(19) United States
(12) Patent Application Publication
(10) Pub. No.: US 2010/0265034 A1
(43) Pub. Date: Oct. 21, 2010

(54) PORTAL ACCESS CONTROL SYSTEM

(76) Inventors: George Jaroslav Cap, Robinson (AU); Ross Woodfield, East Brisbane (AU); Leon Gourdreas, Strathpine (AU)

Correspondence Address: CONNOLLY BOVE LODGE & HUTZ LLP, 1875 EYE STREET, N.W., SUITE 1100, WASHINGTON, DC, 20006, US

(21) Appl. No.: 12/532,931

(22) PCT Filed: Apr. 4, 2008
(86) PCT No.: PCT/AU08/00473

§ 371 Date: Jun. 10, 2010

(30) Foreign Application Priority Data
Apr. 5, 2007 (AU) 2007901807
Feb. 27, 2008 (AU) 2008900930

(51) Int. Cl. G06F 7/04

(52) U.S. Cl. 340/5.71

(57) ABSTRACT

A combination of specific antenna type(s), with a system of specific antenna Rf field deployment, combined with the intelligent sensing of differing micro processor control of a digital antenna attenuator that controls disproportional attenuation (either synchronously or independently) of the transmission and reception areas of the antenna(e), of electronically paired devices, together with conditional time delays, is used to securely determine the ID and intent of an Rf access system user. A multifunctional remote device (condition unit) is carried by a carrier, the remote device transmits a short range radio frequency (Rf) signal which, when within range, is received by a stationary control unit. A second multifunctional remote device (cluster unit) is carried by the operator of the carrier and must be in secure communication with the condition unit to enable secure transmission between the control and the control unit. The operation of both said multifunctional remote units changes significantly with application in differing fields of use. By intelligently varying the interactive antenna Tx and Rx area, the proximity and therefore position of the remote (condition) unit to the base (control) unit can be deduced, outwardly appearing as a decoding of the intent of the carrier. This system can be implemented as a secure card-less RFID entry system for vehicle, building, border entry and mass transit systems.

This invention relates to an automatic access system which does not require any initiation by the person or vehicle approaching a portal such as a door or barrier.

### BACKGROUND TO THE INVENTION

Most portal/access opening systems for vehicles or persons require the user to:
Swipe a proximity card,
Force the user to:
   1) Carry a specific smart entry and RFID device;
   2) Pass through a portal where the electronic interrogation can occur (ie: eTag);
Push a button on a smart entry device (ie: a key fob)
Use electronic biometric scanning applied to parts of the physical body, or
Enter a code that actuates the door or barrier to open.

RFID (Radio Frequency Identification Device) tags and devices can provide information about the identity of the RFID carrier. For example: RFID Tags and RFID Contact-less Smart Cards.

Automatic door opening systems are usually indiscriminate and open when a person or vehicle enters near the range of the proximity sensor. RFID (Radio Frequency Identification Device) tags can provide information about the identity of the RFID carrier but there is no means for determining the intent of the user. U.S. Pat. No. 5,990,828A discloses a garage door opener transmitter system that includes a sensor for determining the relative direction of the garage door opener receiver. The direction of the receiver may be determined based upon a compass and the direction of travel of the vehicle at the time the signal is transmitted. The garage door opener transmitter system transmits a focused wireless signal in a calculated relative direction of the garage door opener receiver. The garage door opener transmitter system includes a sensor for determining a relative direction between the transmitter and the receiver and a beam steerer for directing the signal from the transmitter in the relative direction.

In road toll collection systems RFID transponders are used to identify vehicles. U.S. Pat. No. 6,219,613 discloses a vehicle position determination system for determining the position of a moving vehicle having a transponder includes a first and second antennas operable to receive periodic radio frequency data signals from the transponder when the transponder is moving through a first or second predetermined coverage zone, respectively. The first and second coverage zones partially overlap and each have a width that is orthogonal to the travel path of the moving vehicle and a length that is parallel to the travel path of the moving vehicle. A processor counts the number of periodic data signals received by each of the antennas from the transponder during a time period and determines based on the count a probable location of the vehicle.

There is a need for a hands free, active, Radio frequency (Rf) location-evaluating device, that will allow secure entry through a portal.

U.S. Pat. No. 6,476,732 discloses an automatic garage door operating system using GPS system in the vehicle to indicate to the door control system the proximity of the vehicle.

U.S. Pat. No. 7,071,813 uses barrier control which transmits status signals and a mobile remote controller that uses the status signal to determine the distance between the barrier and the remote control for use in generating barrier opening and closing decisions.

U.S. Pat. No. 7,205,908 discloses proximity control for a barrier in which a mobile transmitter is used with a stationary receiver, associated with a barrier controller, having a limited reception range and the transmitter is programmed to send identification data.

U.S. Pat. No. 7,226,9416 discloses an activation signal which includes a radio frequency (Rf) carrier signal modulated with a code word in a event initiated rolling code format for door/boom gate activation use. A vehicle mounted controller stores the received radio frequency (Rf) carrier signals and receives user input identifying an activation scheme having a rolling codeword format. The controller selects a variable codeword based on the identified activation scheme, selects one of the stored carrier signals and controls the transmitter to transmit an activation signal having the selected carrier signal modulated with the generated rolling code in response to the user input.

U.S. Pat. No. 7,310,043 discloses a controller associated with at least one access barrier and a transceiver associated with the controller for transmitting and receiving operational signals. The system includes at least one proximity device capable of communicating operational signals with the transceiver based upon a position of the proximity device with respect to the barrier and/or the operational status of a vehicle carrying the proximity device.

U.S. Pat. No. 7,170,426 uses a directional antenna and signal strength to determine if a vehicle is entering or leaving and actuates the door appropriately. The proximity of the remote antenna is determined by the signal strength that it ‘sees’ coming from the base antenna. This system is unable to distinguish objects in a queue, because all signals will be summed. This system is unable to determine the position of cars or persons in a queue and is limited to handshaking with one remote unit per portal pass. Further this system is unable to operate within a building because of the serious reflections produced by:
1) the base station antenna power and walls will reflecting the signals
2) standing waves set up in the building by the base station antenna will produce null zones (no signal)
3) the signal strength has the potential to penetrate floors and interfere with other remote and base station devices.

It is an object of this invention to provide a hands free, active, Radio frequency (Rf) location-evaluating device, that will allow secure entry through a portal.

### BRIEF DESCRIPTION OF THE INVENTION

To this end the present invention provides a method of automatically operating a portal and access thereto by determining the intention of an approaching or receding carrier by providing a portable communication device for said carrier and a base unit associated with the control system for said portal in which the power levels between transmission and reception events are varied to determine change in proximity between the base unit and the carrier as an indication of intent to open or close the portal.

Preferably the vehicle carries the portable communication device (condition unit). Preferably the operator of the carrier (if applicable) carries a cluster identification unit to identify the carrier and operator and/or operators/persons associated with the carrier. Communication between the control unit and the condition unit is encrypted to provide a secure system.

The cluster unit (embodied as a portable communication device) is asynchronously in encrypted communication with the said carrier communication device (the condition unit). The said communication between the two devices is prerequisite and essential for successful encrypted communication to occur between the carrier communication device (condition unit) and the control unit.

The Cluster Unit carried by the operator offers a novel system of cluster identification. Enhancing and simplifying security, by enabling the addressing of: Carrier ID together with a group of operators and their ID, as an associated cluster. The system of this invention does not suffer from any of the problems produced by reflections because the signal strength in this invention is kept to a minimum (eg indoors the range will be max @ ˜1.5 meters), negating reflections. The system of this invention is a micro processor controlled field ranging and attenuation system well suited for building interiors (ie a surgeon with sterilized hands walking into a secure room will not have to touch the door and yet pass with security). Through a series of events occurring between a control (base) unit and a carrier, the system of this invention places restraints on the specific variance, either synchronously or independently, of the antenna transmission and reception areas of the said control (base) unit and carrier, so that the simple occurrence of successful communication will indicate the position of the carrier.

The system of this invention easily distinguishes order in a queue so that it can intuitively open boom gates. The system is keyless and requires no actuation by the vehicle operator or person approaching the door.

Preferably the invention incorporates automatic ranging of both transmit and receive signals of a fixed position transceiver and at least one moving (carried) transceiver. The carried transceiver can be electrically/bio-metrically connected/linked to the said carrier and have access to the running state/CPU/alarm/immobilization system and ID of the said carrier. The operator of the carrier (if existing) also carries a transceiver unit which has stored in its memory the ID of the operator.

In the vehicle field of use the operator transceiver (cluster unit) must communicate securely with the carrier transceiver (condition unit) for successful communication to occur with the fixed position transceiver (control unit). Note that the cluster unit and condition unit are configured differently in other fields of use.

This fundamental system design has the capacity for across the board secure access control with practical ‘user friendly’ installation and operation in many diverse fields of use.

This self-sufficient system can be viewed as contained wholly within an inertial frame and equally functional if it were installed wholly on (or within) a transporter to enable access control within said transporter. For example access control on (or within) a transport vehicle such a bus, train or ship. The system of this invention, is a self-contained, secure and self-regulating functional access system that can be also be nested within an identical but larger system.

Auto ranging the reception and transmission areas of an antenna, synchronized/controlled by a micro Processor (uP), creates a novel avenue of application not only in the area of personal, logistic and carrier access, but in larger defined access perimeters of the normalized capability of the Rf irradiated area of a single control unit, or in combination(s)/array(s) of a plurality of control units.

The Condition (or Remote) Unit is carried by a carrier. The stationary Control Unit transmits a short range radio frequency (Rf) signal query which, when within range, is received by the Condition (or Remote) Unit.

Applied digital variance of the interactive antenna transmissive (Tx) and receptive (Rx) areas, dynamically alters the workable communication area between two transceivers. By minimizing the communication area, the proximity and therefore position of the condition unit relative to the control unit can be deduced, outwardly appearing as a decoding of the intent of the carrier/operator. This system can be implemented as a Rf ranging ID entry system, for commercial, non-commercial and personal use.

In the vehicle entry field of use: A more secure system is realized if the Condition Unit is paired with a Cluster Unit (embodied within a key fob attached to the vehicle entry key) and then, set up such that on the loss of encrypted communication with the Cluster Unit, the function of the Condition Unit will be disabled. In this arrangement, both units in paired proximity and in verified encrypted communication are needed to access the Control Unit which in turn controls the portal.

In another aspect this invention provides an automatic actuation system which includes at least one base unit with the ability to be wirelessly paired with a plurality of remote movable units, each unit including
a) an antenna;
b) an antenna driver to power the antennas;
c) an antenna attenuator to control the attenuation and transmissive/receptive area of the antenna;
d) A paired device encrypted communication and transmission system;
e) A micro-controller to control the operation of the unit, and optionally
f) An on board non volatile memory;
g) Device Condition Indicators;
h) Manual Override capability.

By using the appropriate antenna type combination (ie omni directional, directional etc), together with intelligent digital controlling of the broadcast radiation field pattern of the paired antenna(s), the intent of the user can be further refined.

This system can also be easily implemented in other fields of use such as a contact-less RFID entry system, for commercial, non-commercial and personal use.

The system has been designed to operate in the ISM 2.4 GHz band, however similar techniques based on the said system can be applied to any bandwidth. The base unit preferably incorporates with a keypad and LCD Screen for data input and device set up and has
a) an onboard directional antenna that can be attenuated via a digital switch
b) an antenna driver controlled by specific instructions from the micro-processor
c) a receptacle/socket for the ID, pairing and synchronization of remote units
d) access to a onboard memory for example: Card, ROM or Flash etc, which is non volatile and therefore retains what is stored in memory during external power-down events
e) Has a USB data line output for connection to external secure monitoring systems

The remote unit preferably has a separate uni-directional or more preferably a separate omni-directional antenna that can be attenuated via a digital switch and also has
a) an antenna driver controlled by specific instructions from the micro-processor;
b) a plug/connection mechanism for connection to the base unit;
c) access to a onboard memory for example: Card, ROM or Flash etc, which is non volatile and therefore retains what is stored in memory during power-down cycles;
d) LED Condition indicators visually illustrating the operation of the unit;
e) a LED transmission power bar illustrating signal transmission strength;
f) over-ride buttons for manual operation;
g) optionally paired with a proximity unit also on board the vehicle.
   Several remote units may be paired to a base unit.

The remote unit may be optionally paired with a hidden (within the same vehicle) proximity unit and on loss of encrypted communication with this unit, will auto delete its entire memory. This is to prevent a stolen remote unit being used to illegally access a portal.

This invention is particularly useful in the secure active RFID access and control with optional tracking and physical and or electronic mobilization/immobilization of:
1. All carriers through defined portals;
2. All carriers and their operators through defined portals;
3. All ID clusters carried on carriers through defined portals;
4. Electronic interactivity with the carrier/operator with the option of electronic immobilization/restraint of the carrier;
5. Providing alleviation to interactive problems caused by age, illness or physical disability/incapacities;
6. The intuitive opening of all portal types including:
   Large perimeters with multiple entry/exit portals, for example mass transit areas such as train stations and border crossings;
   Large multi-level buildings with multiple entry/exit portals;
   Passageways and tunnels with single/multiple independent access control(s);
   Special Cupboards and storage compartments;
   All restricted access areas that require ID clearance;
   Clean Room restricted class access clearance;
   Operating Theatre access;
   Hazardous area access in research and industry.

### DEFINITIONS

### Activation Key

As part of the initial communication handshaking between devices, every device on initiation receives a system wide activation key, for initial access of the device to the system, after the first interaction with the system the activation key is replaced with a device specific TDES key and that is recorded by the Control Unit in a table, as temporally associated with the Device ID. The IDES Key is updated on every communication event with the device. The activation key is only used to initiate the system, if more devices need to be added to the system a new activation key for just those devices will be implemented and that key will also be superseded (updated) on the first device communication event by a TDES Key update.

The constant update of keys is imperative to the security of the system, any lingering keys could be possible access points.

The Control Unit has a database of paired device ID's and a running history of sufficient recent TDES Key updates for operational purposes.

### Blind Portal

Defined as a single and/or double portal set up as a combined entry/exit portal (or a portal for each single entry and exit). Examples are: garages, corridors, cool rooms, store rooms, passageways or tunnels.

### Carrier:

Defined as a person, robot, machine, vehicle, animal, body or object that either transports from one place to another or carries and has attached either or both of the Condition or Cluster Unit;

### Cluster ID:

Defined as the ID of the carrier associated with the ID of each authorized operator. All these associated ID's are then concatenated into one Cluster ID, saving large database access times. For example: A Cluster ID of a passenger laden vehicle engaged in a border crossing, would be the Compliance plate ID of the vehicle, associated (concatenated) with the ID of all the passengers of that vehicle authorized for the border crossing. This together with a biometric/visual ID of the passengers and the vehicle, would constitute verification of the passenger and vehicle as a group.

### Cluster Area:

Defined as the specific area within the bounds of the designated Cluster Unit's Rf transmission and reception area.

### FIFO:

Defined as an acronym (when applied to queues): First In First Out. Meaning that the first in the queue will be processed first and be first out of the queue.

### FILO:

Defined as an acronym (when applied to queues): First In Last Out. Meaning that the first in the queue will stay in the queue and the oldest will be discarded from the queue.

### Global Key:

In the Mass Transit field of use, a Global Key is used to securely identify all of the Cluster Units embedded within the turnstiles to the Condition Unit (carried by the carrier [person] as a ticketing device), to enable secure access to any turnstile chosen by the carrier.

The Control unit will asynchronously trigger a Global Key update based on a set period and an communication event after, but near the expiry of the said period (that way it will be difficult to predict when an update will exactly occur).

The Control Unit incorporates a database of device ID's and a running history of sufficient recent standard TDES and Global TDES Key updates for operational purposes.

### Group Mode:

Defined as one or more Condition Units paired to a group of (ie: one or more) Cluster Units.

### Handshaking:

Defined as the process of digital signal interchange by which two digital devices or systems jointly establish communications.

### Immobilization:

Defined as restricting the operation of a carrier via electronic means. This may be through an existing carrier, onboard alarm and immobilization system and/or through immobilization of the carrier CPU or any other electronic controller.

ISM 2.4 GHz band:

Defined as the 13 cm frequency band of width 2.4-2.45 GHz, specified for Industrial Scientific and Medical use.

### Key Verification/Update:

Key verification and update is triggered (by the initial handshaking) on every inter unit communication event.

It is defined as the process where:

The newly generated TDES Key is encrypted with the old TDES Key and sent by the Principal Unit to the Responding Unit which, responds by decrypting the new TDES Key via the old TDES Key and encrypts the old TDES Key with the new TDES Key and sends the old TDES Key encrypted with the New TDES Key back to the Principal Unit as a verification.

### Matched Uneven Tx and Rx Fields:

Defined as a disproportionate attenuation of the Tx and Rx field radiation pattern of two transceivers where one transceiver is set up with an attenuated Tx field and unattenuated Rx field and the other is set up with an attenuated Rx field and unattenuated Tx field, such that communication can occur between the two devices.

### Normalization:

Defined as the process of setting up a standard entry procedure by configuring the entry parameters.

### Operator:

Defined as the driver/controller (if existing) of the carrier.

### Portal:

Defined as any device that controls movement or physical access, via entry or exit from a specific entrance or the perimeter of a specific area.

Physical examples are single: doors, roll up and tilt up doors, horizontal and vertically articulated doors, swing, flap, folding and vertical rising doors or gates, radial or sliding gates, moveable barriers, articulated barriers, articulated boom and boom gates, etc.

For increased security a series of double (or multiple) portals can be used, with a requirement that:

Only one of the portals is allowed to be opened during movement or physical access through the (Double/Multiple Portal) system.

Non physical examples use the entry or exit of:
Magnetic and/or electric fields connected separately or in array or in several arrays and
Transmitted bands of the electromagnetic spectrum (ie: UV, Visible light, laser, Infrared, Radio Frequency (Rf) transmitted beam(s)/beacons) in coherent or incoherent mode connected separately or in array or in several arrays;
   That are monitored electronically such that they are able to disable/arrest the movement capability of the carrier if unauthorized.

### Portal Area

Defined as the specific area within the bounds of the designated portal perimeter;

### Principal Unit

Defined as the Unit initiating the request for paired encrypted communication which includes an encryption key update, as well as: ID data, carrier ID status, Carrier Data, Biometric Data, etc.

### Rf Handshaking:

Defined as the process of digital radio frequency signal interchange, by which two digital radio frequency devices or systems jointly establish communications.

### RFID:

Defined as Radio Frequency IDentification

### Rx:

Defined as the Reception field.

### Singular Mode:

Defined as one or more Cluster Units paired to a singular Condition Unit

### The Control (or Base) Unit:

The Control unit is a state of the art transceiver and preferably incorporates:
An onboard directional antenna that can be attenuated via a digital switch;
A software programmed microprocessor controller;
An antenna driver controlled by specific instructions from the micro-processor;
A keypad and LCD Screen for data input and device software set up;
A receptacle/socket for the set up, ID, pairing and synchronization of Condition Units;
Access to a onboard memory for example: Card, ROM or Flash etc, which is non volatile and therefore retains what is stored in memory during external power-down events;
Has a RS-232 data line output for connection to external secure monitoring systems.
Ability to pair with and interrogate a plurality of Condition (Remote) Units (depending on the field of use);
Ability to ID, pair and synchronize with a plurality of Cluster Units;
Ability to control single portals through the Cluster Unit Singular Mode;
Ability to control multiple portals through the Cluster Unit Group Mode;
Optional microprocessor controlled ability for the antenna of this unit to be either electronically (through phase manipulation) or physically (motor driven) rotated;
The capability to communicate with a plurality of other Control Units.

### The Condition (or Remote) Unit:

Defined as a state of the art transceiver carried by the carrier (see definition) and preferably incorporates:
A separate omnidirectional antenna that can be auto ranged via a micro processor;
An antenna driver controlled by specific instructions from the micro-processor;
A plug/connection mechanism for connection/pairing to the Control Unit;
Ability to ID, pair and synchronize with a plurality of Control Units in all modes;
Ability to ID, pair and synchronize with a plurality of Cluster Units in all modes;
Access to a onboard memory for example: Card, ROM or Flash etc, which is non volatile and therefore retains what is stored in memory during power-down cycles;
LED Condition indicators visually illustrating the performance of the primary functions of the unit;
A LED Tx and Rx indicator illustrating signal transmission and reception;
Over-ride buttons for manual operation;
On specific systems without Cluster Units, the Conditional Unit has force open and force close buttons;
Capability to connect with the onboard electrical/biometric system status of the carrier;
Onboard capability and or the capacity to connect with the onboard electrical/biometric system of the carrier to determine the Biometric/Electrical ID of the carrier;
Onboard capability to connect with the onboard electrical systems of carrier (if applicable) to immobilize the movement of the carrier.
   One Control unit and one Condition unit is the minimum configuration of this access system.

In the vehicle field of use: The antenna could be placed freestanding on the dash board or fixed to or embedded within the windscreen or embedded in the visor, rear vision mirror, dashboard or other suitable locations on the body of the vehicle. In other fields of use the condition unit may be incorporated in a mobile phone, enabling the said mobile phone as an access device. The said condition unit may also incorporate a USB receptacle for data exchange and/or battery charging.

### The Cluster (or Proximity) Unit:

Defined as a state of the art transceiver carried also by the carrier or operator. In the vehicle entry field of use:

The Cluster unit is embodied within a key fob attached to/or as part of the vehicle entry key carried by the carrier. Preferably the battery of the said cluster unit as part of the entry key will be automatically charged on/while the said entry key is engaged in the ignition.

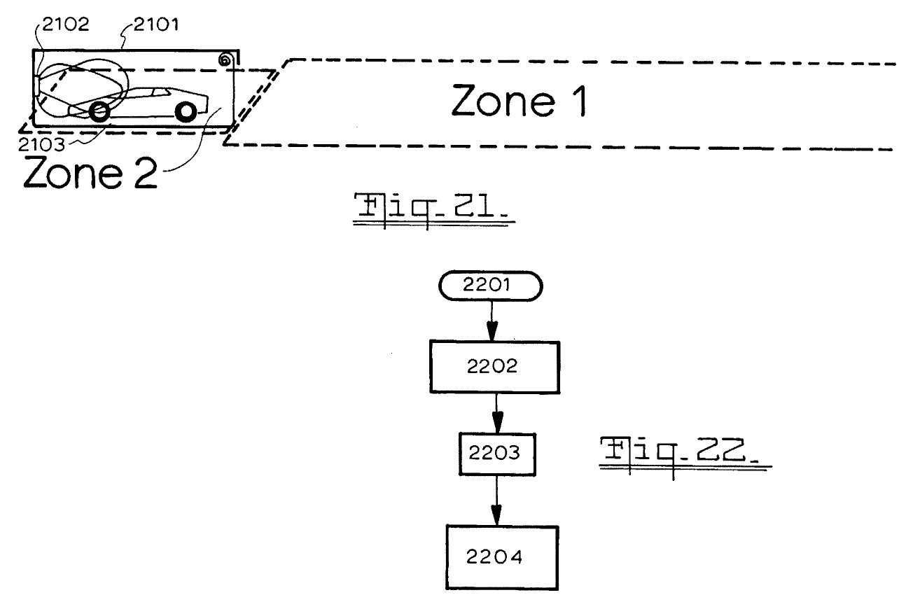

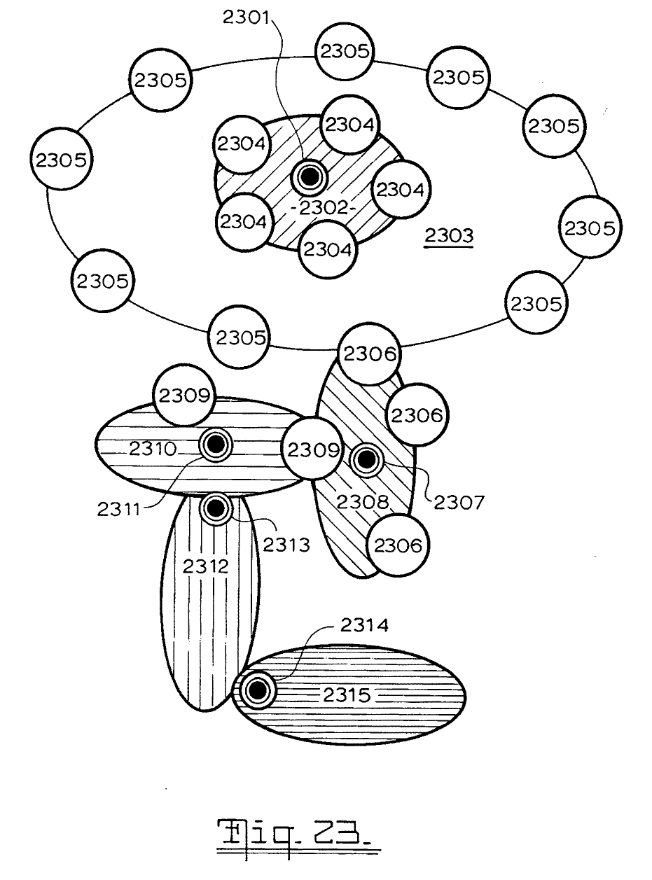

One of the several benefits of adding the cluster unit to the system, is its capability to prevent a stolen condition unit functioning after removal from the vehicle. Other beneficial attributes are:
For Singular Mode deployment, the Cluster Unit is deployed with a single paired Control Unit and Condition Unit (minimum preferred deployment), for blind portals.
Group Mode deployment is not generally used in this field of use, except in the case of: Multiple Single Gate Sequential Entry Systems (in building and underground parking facilities). The more general use of Group Mode deployment is in the mass transit field of use, where the Cluster Units are deployed as embedded within turnstiles with one or more paired Control Unit(s) and a plurality of Condition Units, for secure access control of areas with multiple exits and/or entry portals (FIG. 23). Note that: The operating system in this deployment is different to that of the singular mode (see Cluster Unit Software Operation Group Mode).
For singular deployment (in the vehicle entry field of use) the Cluster Unit is:
   a. Preferably attached to the carrier entry key and carried by the operator;
   b. Combined with force open and force close buttons in a key fob;
   c. Paired with the Condition Unit of the same carrier;
   d. In asynchronous encrypted communication with its paired Condition Unit;
   e. Has the electronic ID, data, Info and other ID variables of the carrier stored in its memory for ID verification;
Has the electronic ID and other ID variables of all paired Control Units stored in its memory for ID verification;
Fitted with an on board (PCB) or separate external omnidirectional antenna;
Both a Condition and Cluster Unit in paired proximity are needed to engage successful communication with the Control Unit (and therefore access through the portal).
On loss of encrypted communication with the Condition Unit, the function of the Condition Unit will be disabled and portal access denied;
   In the Mass/Other transit field(s) of use the Cluster Unit also incorporates:
A form factor embedded in a turnstile;
Power from mains power.
A separate omnidirectional antenna that can be auto ranged via a micro processor;
An antenna driver controlled by specific instructions from the micro-processor;
Capability of the control and communication with disproportional Tx and Rx fields;
Capability to connect with the onboard electrical/biometric system status of the carrier;

### TDES:

Defined as an acronym of the Triple Data Encryption Standard (TDES) system. The triple-DES system uses a well documented process using two 56-bit DES keys (totaling 192-bits of encryption) at different times during separate encrypt, decrypt and re-encrypt operations.

### Tx:

Defined as the transmission field.

### Uneven Rx Fields:

Defined as a disproportionate attenuation of the Tx and Rx field radiation pattern of a transceiver so that the Tx field is attenuated disproportionally more than the Rx field of the transceiver.

### Uneven Tx Fields:

Defined as a disproportionate attenuation of the Tx and Rx field radiation pattern of a transceiver so that the Rx field is attenuated disproportionally more than the Tx field of the transceiver.

uP:

Defined as the micro-processor

### Zone 1:

Defined as the long range detection area of the Control Unit (outside zone 2) for detection of both the Condition Unit and the Cluster Unit (see FIG. 19)

### Zone 2:

Defined as the short range detection area of the Control Unit for detection of both the Condition Unit and the Cluster Unit. In the vehicle entry field of use: The case of garaged vehicular access zone 2 would be the garaging (vehicle parking) area (see FIG. 19).

### DETAILED DESCRIPTION OF THE INVENTION

A number of embodiments of the invention will be described with reference to the drawings in which:

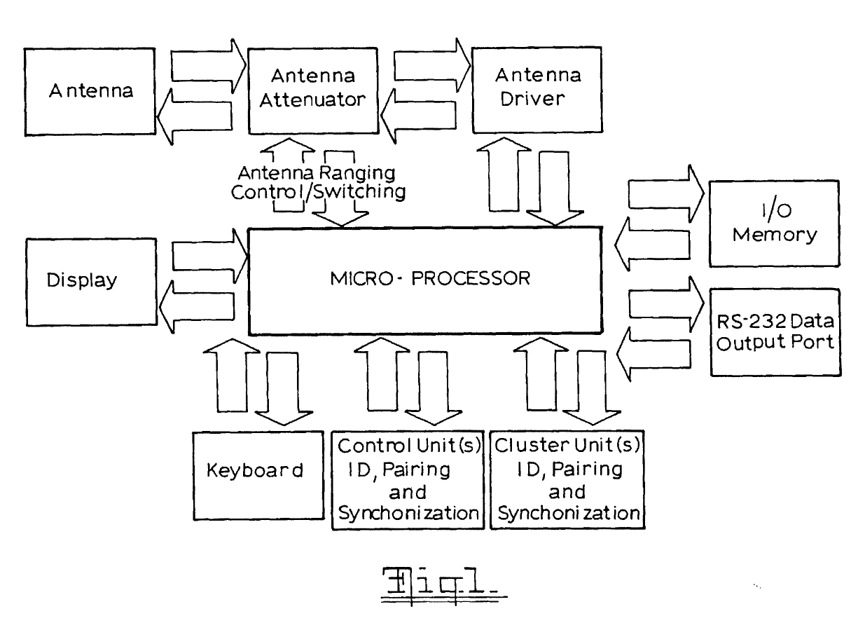

FIG. 1 illustrates a block diagram of the major components of the Control Unit;

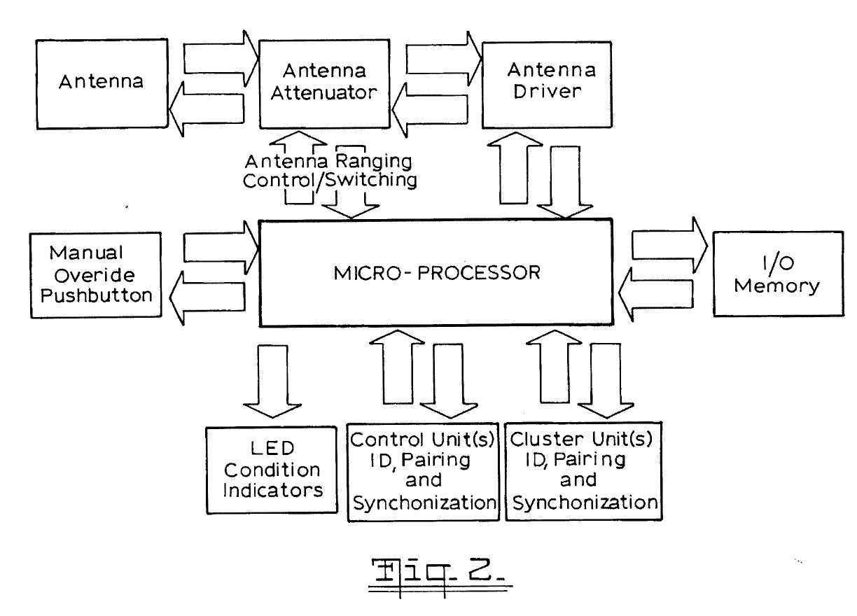

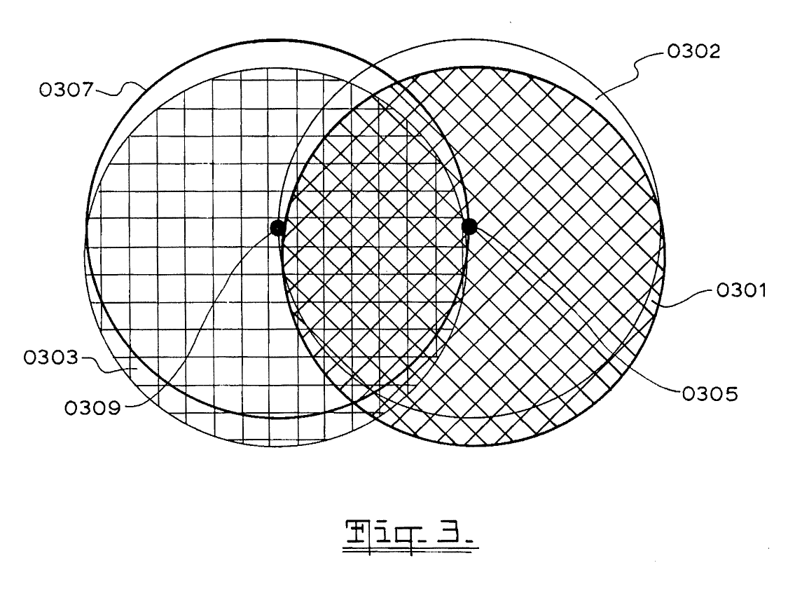

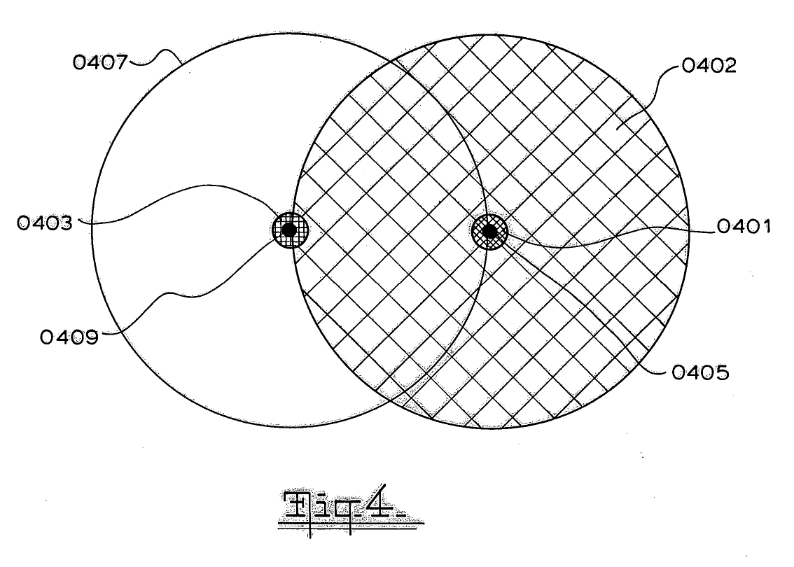

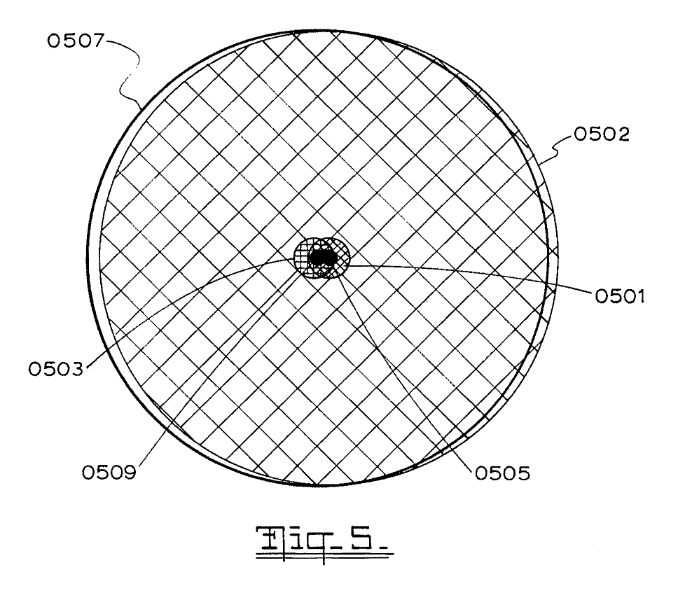

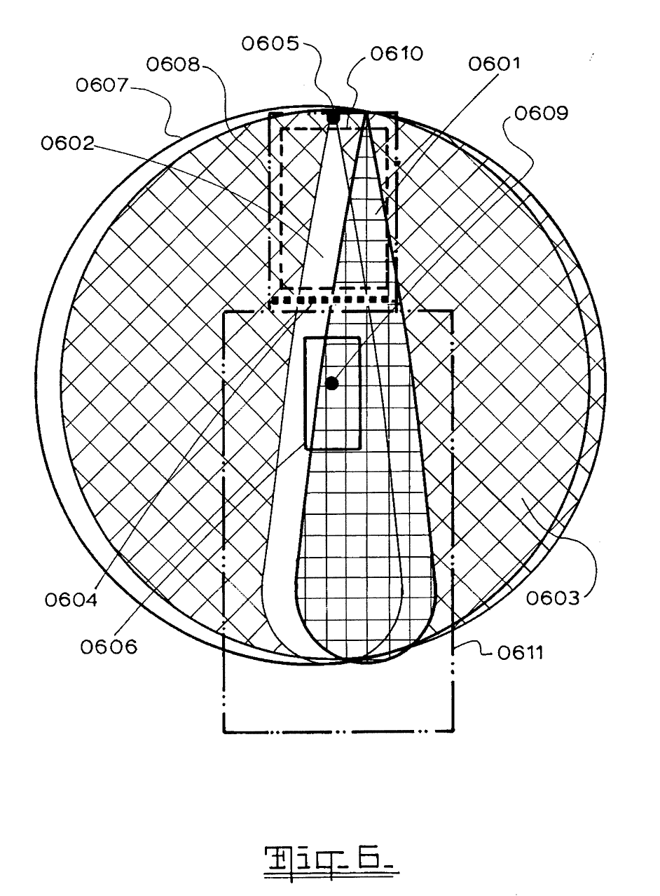

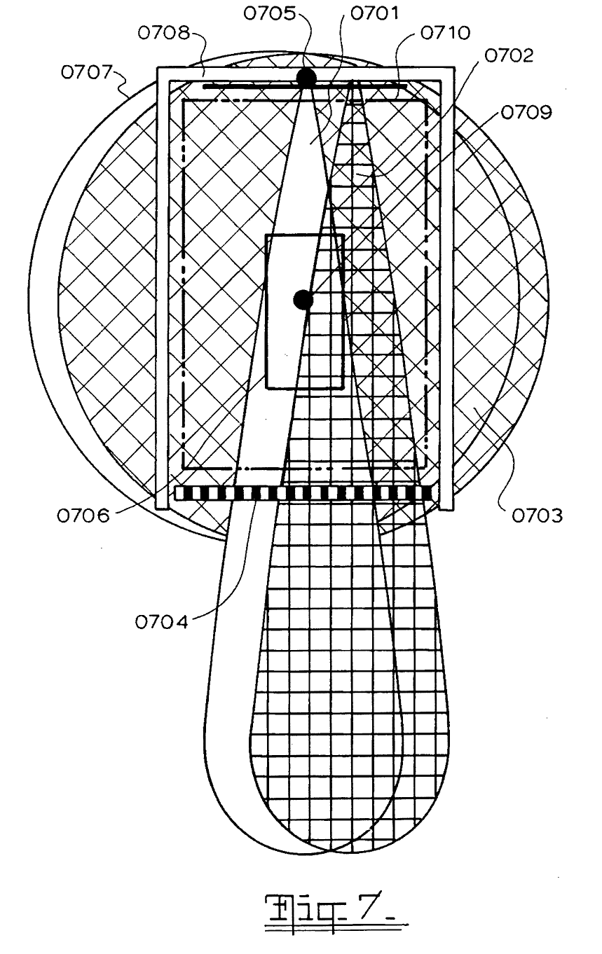

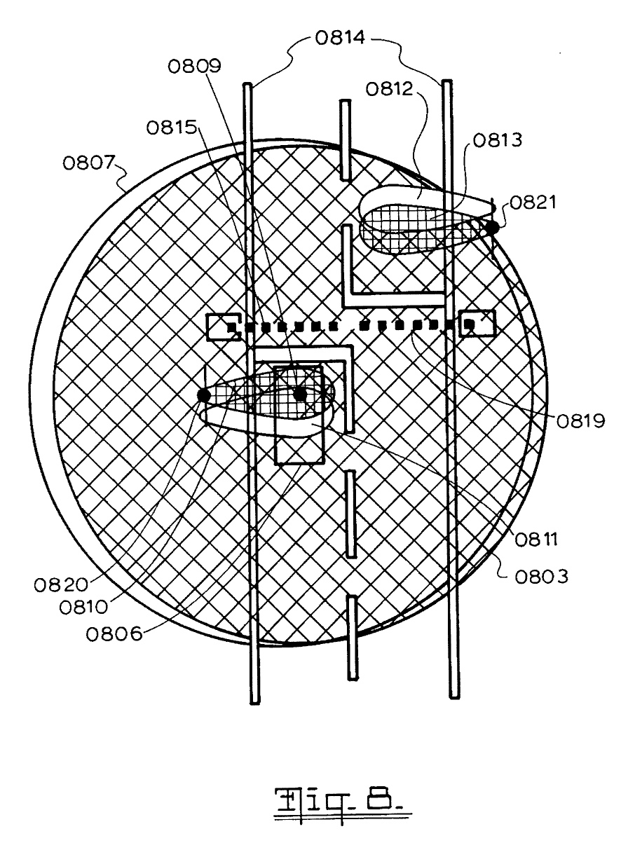

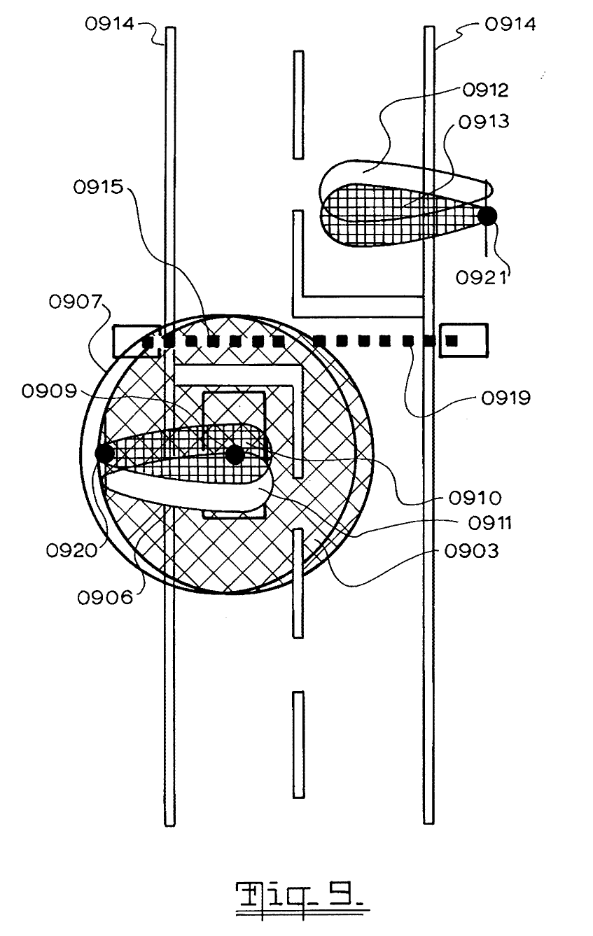

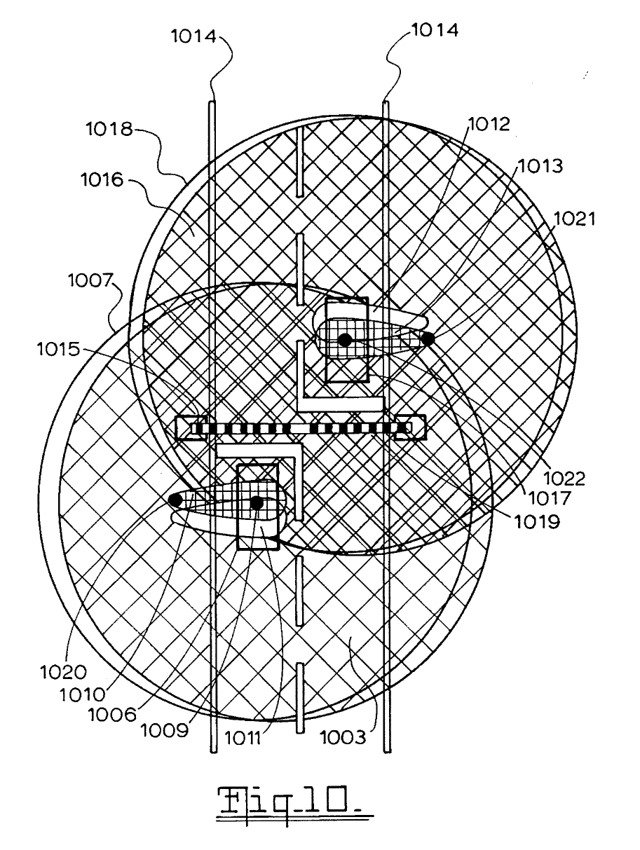

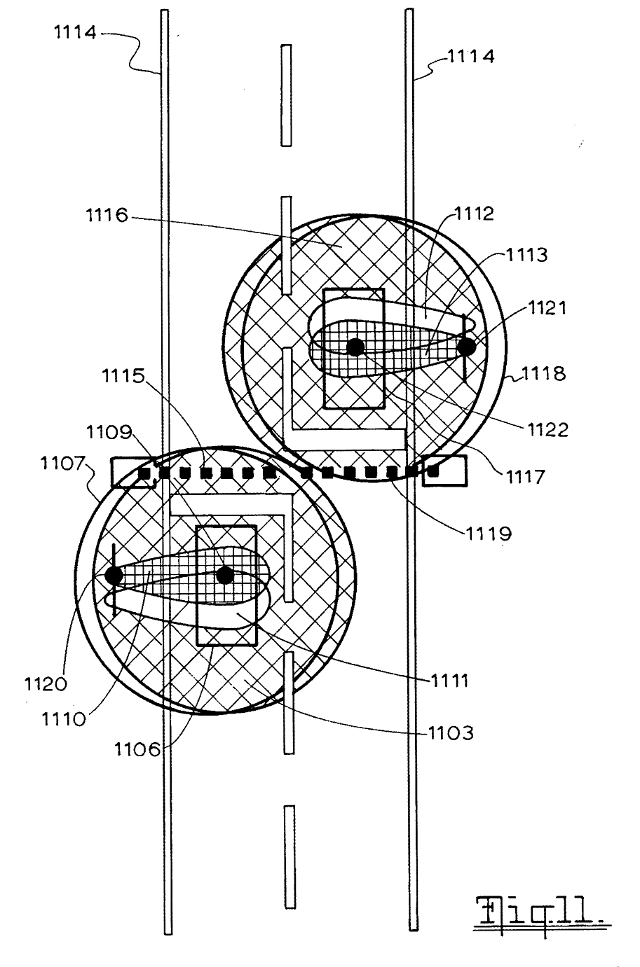

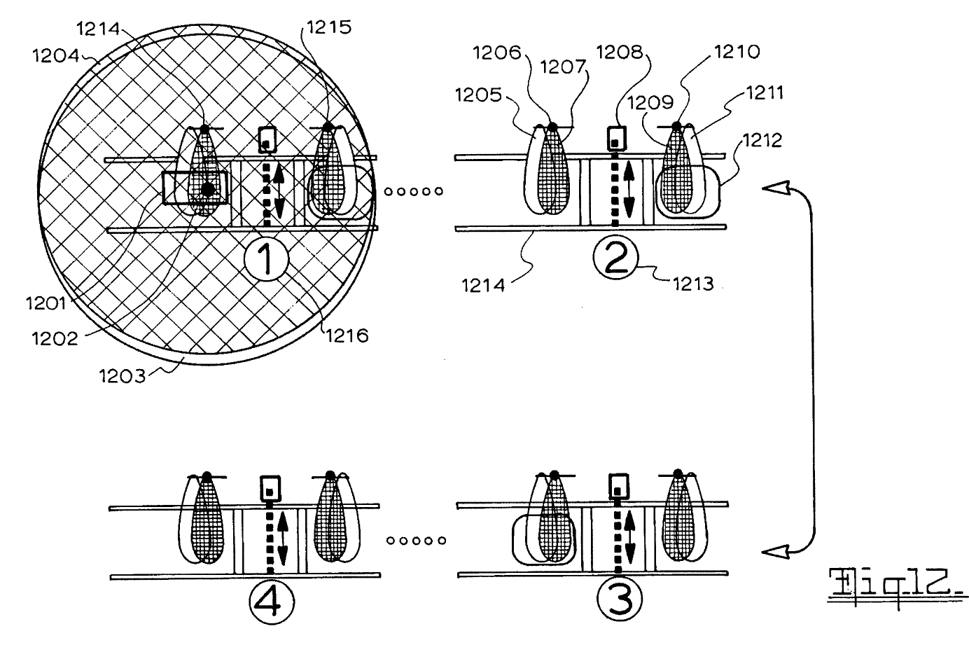

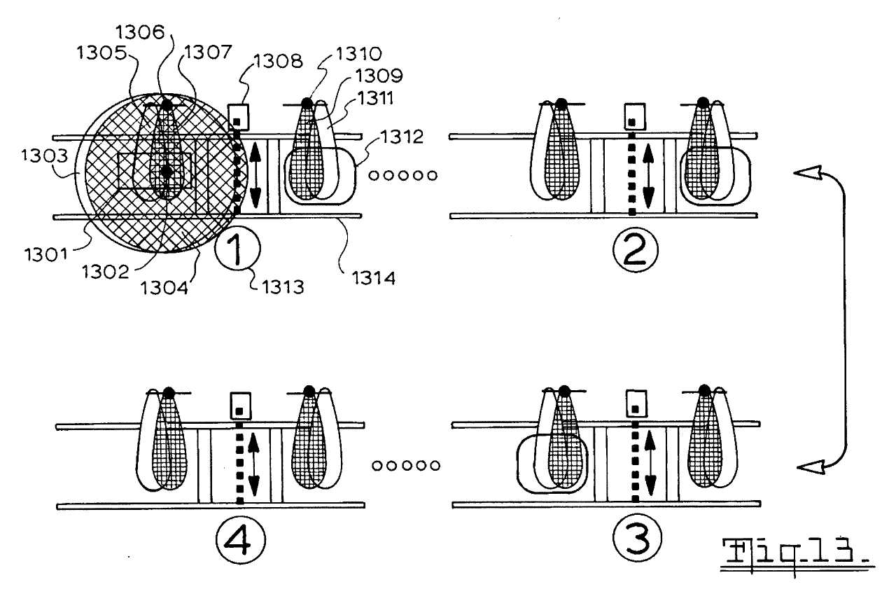

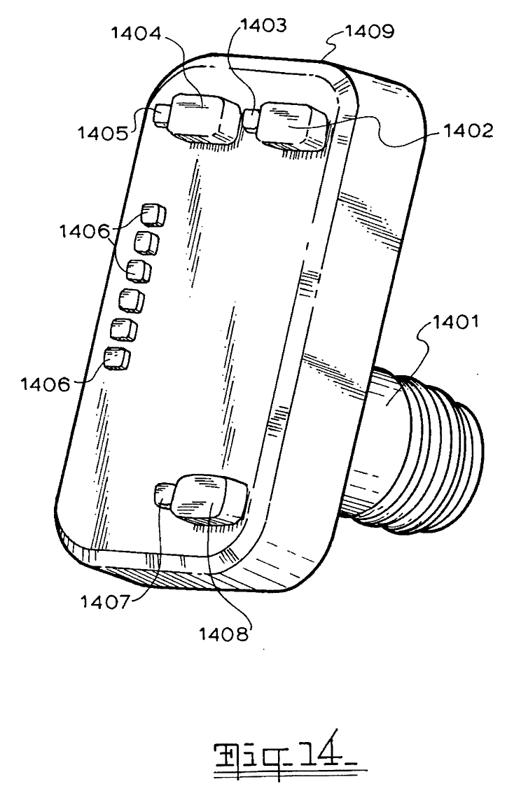

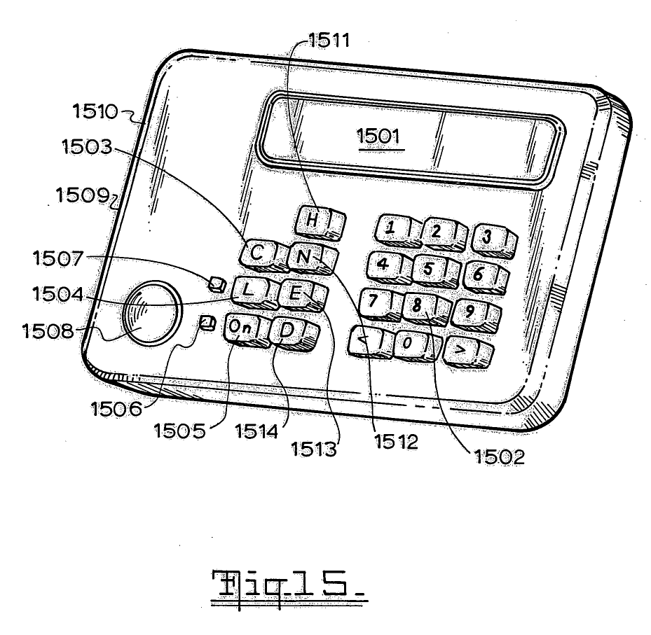

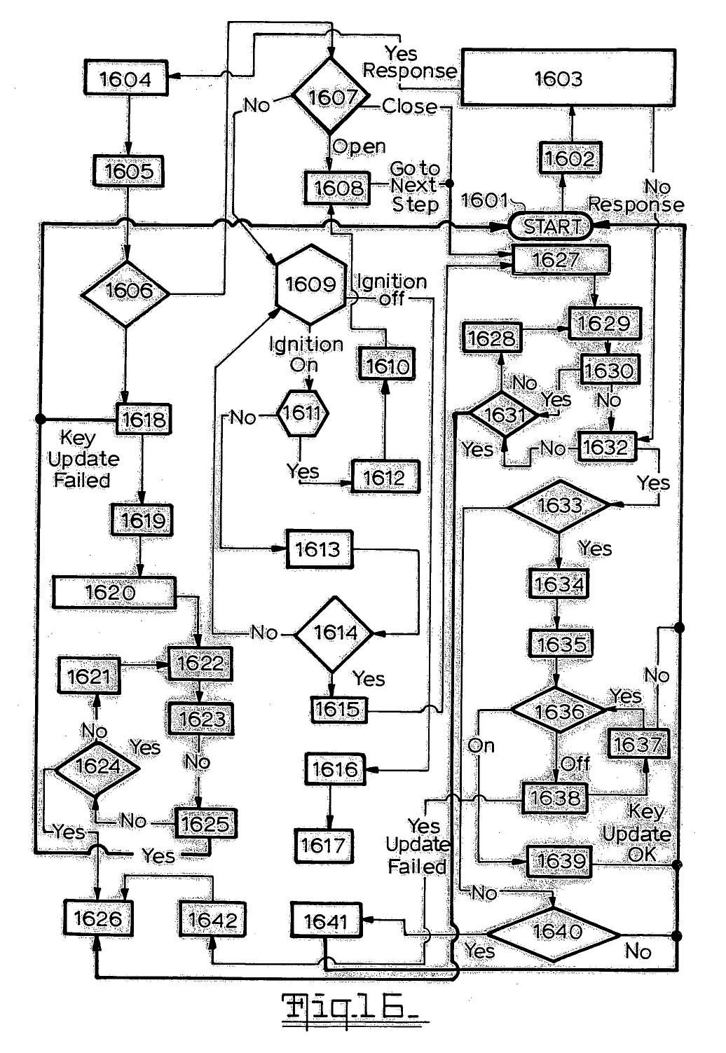

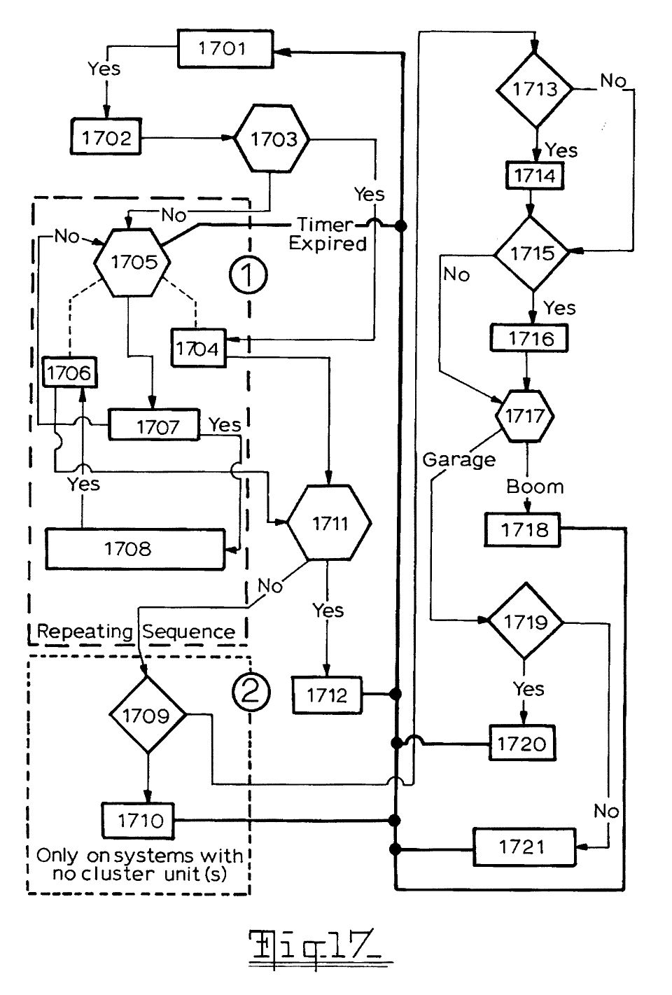

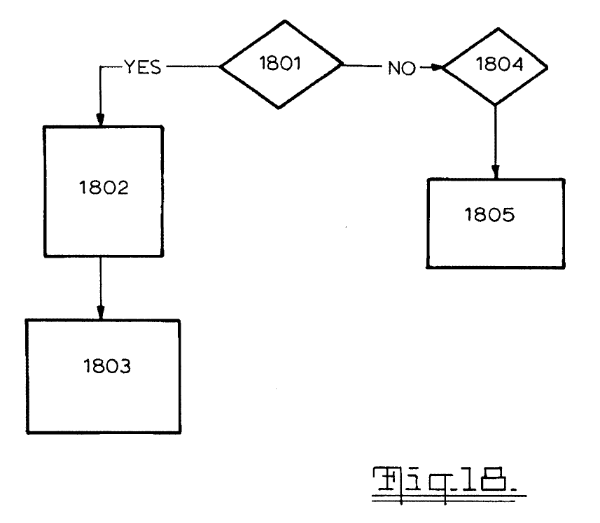

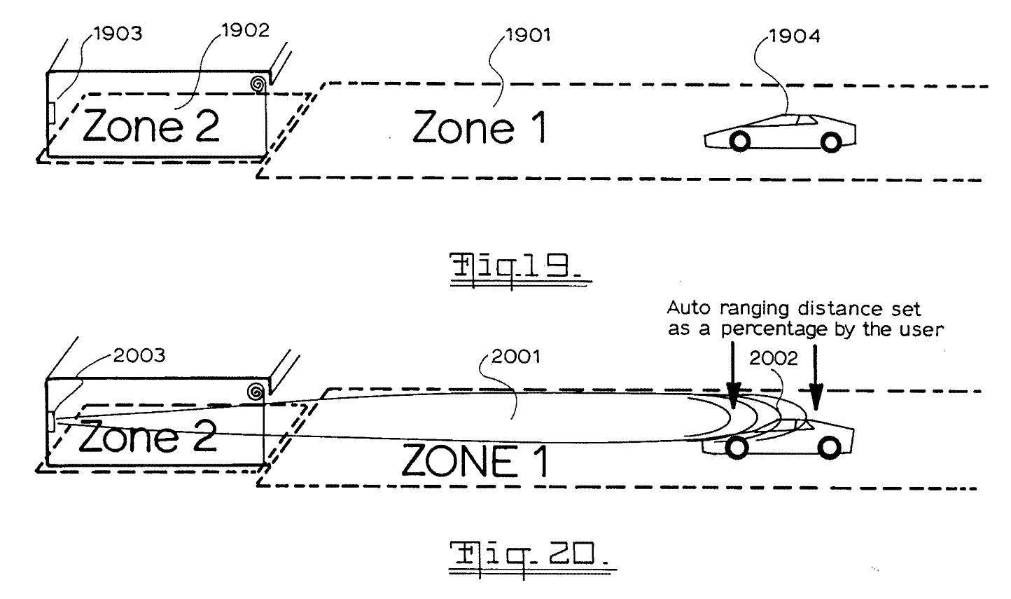

FIG. 2 illustrates a block diagram of the major components of the Condition unit;

FIG. 3 illustrates an even (normal) pattern of communication between two antennas and their transmitting (Tx) and reception (Rx) fields.

FIG. 4 illustrates an uneven radiation pattern where the transmitting field radiates with much less power than the receptive field. The antennas illustrated will not communicate properly.

FIG. 5 illustrates the position where the uneven radiation pattern fields of antennas of FIG. 4 will communicate.

FIG. 6 illustrates the Rf radiation field patterns of the Control Unit with unattenuated radiation patterns and a Condition unit placed in a vehicle approaching a garage with unattenuated radiation patterns;

FIG. 7 illustrates the Rf radiation field patterns of the Control Unit with unattenuated radiation patterns and a Condition Unit placed in a vehicle approaching a garage with attenuated radiation patterns;

FIG. 8 illustrates the Rf radiation field patterns of two Control Units with unattenuated radiation patterns and Condition Unit placed in a vehicle approaching a boom gate entry system, at the entry position with unattenuated radiation patterns;

FIG. 9 illustrates the Rf radiation field patterns of two Control Units with unattenuated radiation patterns and Condition Unit placed in a vehicle approaching a boom gate entry system, at the entry position with attenuated radiation patterns;

FIG. 10 illustrates the Rf radiation field patterns of two Control Units with unattenuated radiation patterns and a Condition Unit placed in each of two vehicles approaching a boom gate entry system with unattenuated patterns. One vehicle is in the entry position and one in the exit position;

FIG. 11 illustrates the Rf radiation field patterns of two Control Units with unattenuated radiation patterns and a Condition Unit placed in each of two vehicles approaching a boom gate entry system with attenuated radiation patterns with one vehicle positioned in the entry position and the other in the exit position;

FIG. 12 illustrates the unattenuated Rf field pattern of a Condition Unit contained within a vehicle approaching a multiple single-gate entry system of four gates, where the gates allow different levels of security;

FIG. 13 illustrates the attenuated Rf field pattern of a vehicle containing a Condition Unit approaching a multiple single-gate entry system of four gates, where the gates allow different levels of security;

FIG. 14 illustrates the Condition Unit;

FIG. 15 illustrates the of the Control Unit;

FIG. 16 illustrates the Control Unit generalized logic flow diagram;

FIG. 17 illustrates the Condition Unit generalized logic flow diagram;

FIG. 18 illustrates the Cluster Unit generalized logic flow diagram;

FIG. 19 illustrates the defined zone areas;

FIG. 20 illustrates the auto ranging function after normalization;

FIG. 21 illustrates the sentry mode in operation;

FIG. 22 illustrates the Encryption Key Update Sequence generalized logic flow diagram;

FIG. 23 illustrates varied Cluster Unit deployments illustrating several applications;

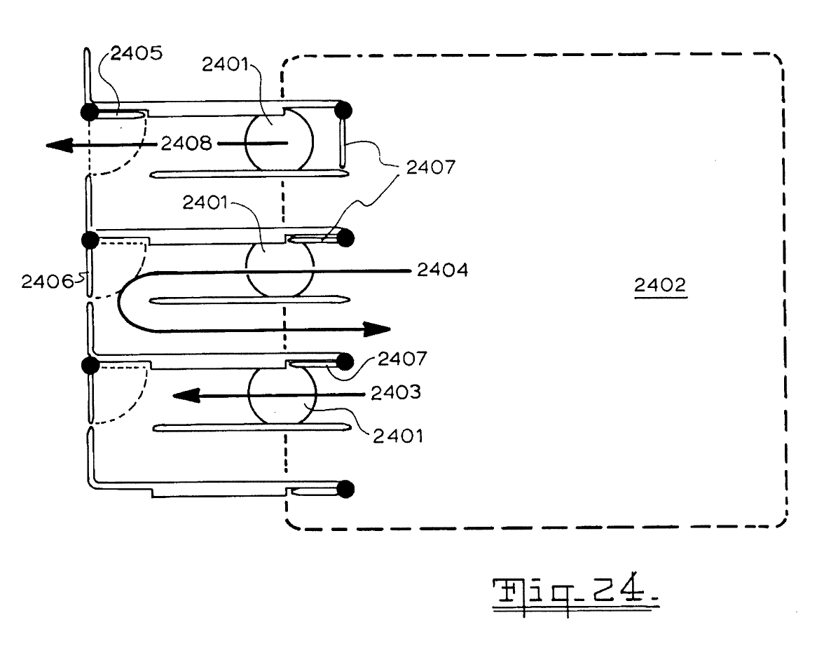

FIG. 24 illustrates Cluster Units embedded within turnstiles in the mass transit field of use;

FIG. 25 illustrates the Tx & Rx field of the Control Unit in isometric view, with the Cluster Units placed on the perimeter of the said Control Unit field, and the Condition Units within the perimeter of the said Control Unit field;

FIG. 26 illustrates a side view of FIG. 4 (as a precursor to FIG. 27), with the Tx and Rx fields of the each device separated vertically for illustration purposes only;

FIG. 27 illustrates the interaction of two Condition Units in disproportionate receptive field mode.

The major components of the system of this invention are the control unit and the condition units.

FIG. 1 schematically shows the main functions of the control unit.

FIG. 15 illustrates one possible form of a control unit.

The Control unit includes:
A power on/off button (1505) with a LED (1506) condition indicator
A electronic lock/unlock button (1504) with a LED (1509) condition indicator
A LCD Display for data in/out (1501)
A Key pad for data in/out & set up conditions (1502)
A Force Close Over-ride button (1503)
User programming system Home button (1511)
User programming system New button (1512)
User Programming system Edit button (1513)
User Programming system Delete button (1514)
A socket receptacle for the Condition Unit connection plug [for unit induction, set up and programming (1508)]
A socket for data cable connection to a Condition unit (1510)
A RS-232 data line output for connection to external secure monitoring systems (1509)

FIG. 2 schematically shows the functional operation of a condition unit of this invention.

FIG. 14 illustrates a preferred form of the condition unit.

The Condition Unit includes:
A power on/off button (1404) with a LED (1405) condition indicator
A electronic lock/unlock button (1402) with a LED (1403) condition indicator
A Tx signal strength vertical bar LED (1406) indicator
A Force Close Over-ride button (1408) with a LED (1407) condition indicator
A car lighter plug (1401) for access to 12 volt power, charging of on board batteries and ignition status monitoring
A socket for data cable connection to a Control unit (1409)
   Principle of operation

FIG. 3 illustrates two radio frequency (Rf) transmitters (0309 and 0305) in a position of maximum separation with ongoing communication, further separation will force the communication to drop out.
Transmitter (0305) has a transmissive (Tx) field (0301) and the receptive (Rx) field (0302), note that the transmissive field (0301) has been offset from its central position for illustrative purposes only.
Transmitter (0309) has a transmissive (Tx) field (0303) and the receptive (Rx) field (0307), note that the transmissive field (0303) has been also offset from its central position for illustrative purposes only.

FIG. 4 illustrates the two radio frequency (Rf) transmitters from FIG. 3, with both the transmissive components of the transmitters (0401 and 0403) attenuated. In this configuration no two-way communication (Rf handshaking) can occur between the two devices.

FIG. 5 illustrates the position in which the Rf transmitters of FIG. 4 can communicate. The Tx field and Rx field of each device require that the Rf transmitter be placed such that the Tx and Rx fields of each device can excite and sense the fields developed within the antennas of the other.

If one of the antennas is stationary and the other moving and:
If the Tx transmission ranges of both the unattenuated and attenuated antenna are known;
Rf handshaking occurs and;
The attenuation of the antenna is known.

An accurate position/location of the moving antenna can be established to be somewhere within the overlapping transmission fields of both antennas. Reducing the transmission range of either antenna will increase the accuracy of this position/locating system.

In the garage entry field of use:

The Control Unit will be housed in the garage (often called the Garage Unit) and

The Condition Unit will be carried by a vehicle (often called the Remote/Car Unit).

The Cluster Unit will be carried by the operator of the vehicle (often called the Proximity/Key fob Unit).

### General Protocol and Procedures

### Activation Key and Encryption Update Procedure:

As part of the initial communication handshaking between devices, every device on initiation receives a system wide activation key, for initial access of the device to the system, after the first interaction with the system the activation key is replaced with a device specific TDES key and that is recorded by the Control Unit in a table, as temporally associated with the Device ID. The TDES Key is updated on every communication event with the device.

### Transmitted Key Database Protocol

The Control Unit has in its database a table of the paired carriers/operators with ID's and a running history of sufficient TDES Key updates for operational and contingency purposes. Each Responding Unit (ie: all units) also incorporate a running history table (database) of sufficient TDES Key updates. The TDES Keys are placed in a communication TDES Key stack (the number of registers depending on the required security). When a new TDES Key is generated it is placed on top of the stack forcing the older TDES Keys down a level in the stack, discarding the displaced bottom TDES Key (FILO system).

### TDES Encryption Update Procedure

The Control Unit (as the Principal Unit) generates the 192 bit encryption key and checks:
If the new key is a weak key;
If the new key has been used previously.

If the new key passes the above tests, the Control Unit encrypts this new key with the old key and sends the encrypted message to the responding unit (either Condition or Cluster). The responding unit decrypts the new key with the old key and sends the old key encrypted with the new key as a validation of the key update procedure (FIG. 22).

Key update events occur:
After every successful handshaking event—between the Control and Condition Units (including unforced open/close procedures);
Before the handshaking event (1) and after a successful handshaking event between the Principal and the Responding Unit;
Periodically during sentry mode between the Control and Condition Unit, and
As part of the force open/close procedure.
When a force command is issued by the Cluster Unit (to the Control Unit), the Control Unit will create a new tested key and request verification, authentication by sending it to the Cluster Unit. Only after a successful authentication will the Control Unit decrypt and execute the force command.

### Normalization Procedure:

For the vehicle/garage entry field of use: The Control Unit will need to be normalized so as transmission will occur in zone 1 (FIGS. 19, 1901).

Note that: The Condition Unit will mimic the field setup of the Control Unit on entry into zone 1 (FIG. 17, 1708 [2]).

The installer (or user) will set up the garage unit by:
Enabling the normalization mode of the Control Unit;
Set the normalization mode elemental variation range (usually between 1-2 meters);
With:
   1) The vehicle parked at the preferred detection distance (within zone 1) from the garage door and
   2) The garage door closed and
   3) The with the ignition in the on position and
   4) (Using the secure option)—The Cluster Unit attached to the ignition key;
Activate the normalization mode—auto ranging function from the keypad on the Control Unit (FIG. 19, 1903);
Confirm and store the setting as default.

The activation of the auto ranging function, will, in normalization mode auto range the Control Unit's antenna field strength in increasing digital steps until handshaking is attained with the Condition Unit.

This process will:
Set the default range of the Control Unit to the user preferred operational distance (FIG. 20, 2002);
Set the default ranging start point for the continuous (elemental variation range) auto ranging function (FIG. 20, 2002).

### The Operational Details

For the vehicle/garage entry field of use: FIG. 6 illustrates the Radio Frequency (Rf) fields involved for a Control Unit (0605) installed in a garage (0608) and a Condition Unit (0609) installed in a vehicle (0606).

The Rf antenna used with the Control Unit (0605) is a directional antenna preferably a Patch Antenna, but other directional antennas can be used for example: a Yagi or Periodic Antenna.

The Control Unit (0605) antenna has been set up (normalized) for a user defined optimal Tx (0601) (FIG. 6 square cross hatch) and Rx (0602) (FIG. 6 grey) radiation field deployment so as to communicate with a vehicle (0606) placed in front of the garage door (0604).

The radiation patterns are offset for illustration purposes only and in reality are co-aligned along their major axes sourcing at the control unit (0605).

The Rf radiation patterns Tx (0603) and Rx (0607) fields of the Condition Unit (0609) in the vehicle (0606) are both unattenuated.

The fields Tx (0603) (FIG. 6 diagonal cross-hatch) and Rx (7) (FIG. 6 white fill) are offset for illustration purposes only and in reality are co-centric with the Condition Unit (0609).

### Mode 1

In the case of an approaching vehicle (0606) carrying a Condition Unit (0609) as in FIG. 6 with:
Both Tx (0603) and Rx (0607) of the Condition Unit (0609) in unattenuated mode and
Both Tx (0601) and Rx (0602) of the Control Unit (0605) are also in unattenuated mode,
These combined settings are defined as mode 1 settings;
The location extending from the front of the garage portal to within the garage itself is defined as zone 1 (FIG. 6, 0611 and FIG. 19, 1901);
The position in the software procedure diagram (FIG. 16, path: 1601→1603).

The Control Unit (FIG. 6, 0605) periodically transmits a handshake request and then listens for a response from any paired Condition Unit (FIG. 6, 0609).

When the Condition Unit (0609) is in transmission range (within zone 1 as illustrated in FIG. 6) Rf handshaking protocol is initiated between the Control Unit (FIG. 6, 0605) and the Condition Unit (FIG. 6, 0609).

### Software/Hardware Operation

Note: The software flow diagrams (FIGS. 16, 17 & 18) are biased toward the garage entry field of use. Some indications to the modifications needed for other fields of use are shown.

In FIG. 16 the software components are
1602 identify control unit typeeg boom or garage door;
1603 control unit transmits periodic quey to detection zone for any condition unit to respond;
1604 valid I D established via encrypted communication with responding paired unit;
1605 stop communicatinmg with cluster unit only if singular;
1606 check for control unit configuration;
1607check for force open/close command receipt;
1608 open portal command
1609 set attenuation normalized garage mode then check ignition status;
1610 reset entry/exit flag;
1611 check entry/exit flag;
1612 vehicle parked in garage;
1613 vehicle has entered zone 1 & is authorized, commence countdown timer;
1614 timer expired;
1615 open portal;
1616 vehicle parked outside garage;
1617 portal remains closed except for force open command receipt;
1618 set attenuated field; boom mode and update key;
1619 open boom;
1620 wait fixed time period;
1621 wait fixed time period;
1622 start/continue close boom;
1623 obstruction;
1624 boom open too long?;
1625 Boom closed;
1626 engage warning (push button to disengage);
1627 wait fixed time period;
1628 wait fixed time period;
1629 start/continue close portal;
1630 obstruction?;
1631 portal open too long;
1632 portal closed;
1633Check if sentry mode enabled;
1634 begin/continue sentry mode;
1635 set sentry and entry flag on;
1636 check ignition on;
1637check sentry flag on;
1638 execute encryption key update and wait fixed time period;
1639 reset sentry flag;
1640 check if vehicle is garaged
1641 set entry/exit flag;
1642 send vehicle immobilization command.

In FIG. 17 the software components are:
1701listen for control unit query;
1702 respond and establish I D via encrypted communication with control unit;
1703 check for discontinue cluster unit polling command from control unit;
1704 stop timer;
1705 count down timer;
1706 reset timer;
1707 query paired cluster unit to respond;
1708 respond and establish ID with cluster unit, pause for a fixed time period then mimic field attenuation of control unit;
1709 check for force command from condition unit only;
1710 send the force command to control unit and flash onboard LED on authorized reception of command;
1711 check for carrier immobilization command from control unit;
1712 execute the immobilization command by disabling the vehicle CPU or enabling vehicle alarm system;
1713 check for ignition status enquiry command;
1714 get and send ignition staus to control unit;
1715 check for other ‘n’ status enquiry command;
1716 get and send other ‘n’ status to control unit;
1717check for control unit type (boom/garage or other);
1718 if Boom type rest condition unit to boom mode;
1719 check for sentry flag enabled on control unit;
1720 set condition unit to sentry mode;
1721 rest condition unit to sentry mode.

In FIG. 18 the software components are:
1801 check for force command issued by this cluster unit;
1802 respond, establish I D, request key update and authenticate via encrypted communication with control unit;
1803 execute the force command to control unit and flash on board LED on authorized reception of command;
1804 listen for condition unit query;
1805 respond and establish I D via encrypted communication.

In FIG. 22 the software components are:
2201 principal unit 1 start with old key;
2202 principal unit generates and checks new key for weakness and previos use;
2203 principal unit encrypts new key with old key and sends to responding unit;
2204 respondng unit decrypts new key and sends to base the old key encrypted with the new as validation.

Those skilled in the art will realize that other fields of use will require specific modifications to these flow diagrams as indicated in their respective descriptions.

### Control Unit Software/Hardware Operation

Control Unit Encryption Key Generation

After establishing the handshake protocol, the Control unit then generates a new encryption key. The Control Unit then tests the new key for strength (some keys are easily hacked) and uniqueness (checking if the generated key has been used before) see FIG. 22. With a successful scrutiny of the new key, the Control Unit proceeds to encrypt the new key using the previous key (FIG. 22, path: 2201→2204). If the Control Unit is in Singular mode, once the ID of the Condition Unit is authorized and while in communication the Control Unit instructs the Condition Unit to stop polling the Cluster Unit (see Condition Unit Operation for details).

The operational software has been designed to be universal and will operate on almost all physical portals, each Control Unit will be initialized with a code for the portal type that it operates. Checkpoint 1606 (FIG. 16) will assess the portal code and engage the relevant software that is specific to the portal type. The checkpoint 1606 illustrates only two options of many possible portal types.

### Boom Gate

For the vehicle/garage entry field of use, Boom Gate Option: Both of the Rf antenna fields of the Control and Condition Units are attenuated (FIGS. 8: 0807, 0803 and 9: 0907, 0903). As authorization of the Condition Unit has been established, the boom gate will be opened by the Control Unit. Also while the Condition Unit is approaching/passing the opened boom gate, the area directly under the boom itself is continually scanned for the presence of obstructions (ie: including the passing of the vehicle) and will remain open until the obstructions are cleared (FIG. 16, path: 1620→1622→1623→1625→1624→1621). The boom is also allowed to be open for a fixed time period after which if still open, the system will engage obstruction/tampering alarms (FIGS. 16: 1624 and 1626).

Note: Alarm systems may include other options like vehicle alarm activation or in the extreme case: vehicle immobilization (FIGS. 17: 1711 & 1712).

Note also: In the field of use of: Mass Transit, secure access control, the obstruction sensors are deactivated as obstructions will be people without authorized ticketing and are directed away from the portal (FIG. 24).

Double sequential Portals are a more secure option and use the same principles as multiple sequential gates (see Multiple Single Gate Sequential Entry System).

### Garage Portal

If the checkpoint (FIG. 16: 1606), indicates the Garage portal type, the system arrives at checkpoint FIG. 16, 1607: The check for a force open/close command receipt by the Control Unit. For a Force Open Command, authorization has previously occurred and still valid, the Control Unit Opens the Portal.

### Garage Portal Force Close Sequence

For a Force Close Command, again authorization has occurred, the Garage Portal area directly under the Garage Portal itself, is continually scanned for the presence of obstructions (ie: including the passing of the vehicle) and will remain open until the obstruction(s) are cleared. The Garage Portal is also only allowed to close for a fixed time period (FIG. 16: 1626), after which if still open, the system will engage obstruction/tampering alarms (FIGS. 16: 1625 and 1623). The alarms can be reset with a double press of the Force Close Button (FIG. 16: 1626), on the Control Unit only (see: Garage Entry Process for more detail).

### Ignition Status Request

If checkpoint (FIG. 16: 1607) indicates no force open/close commands, the system arrives authorized for entry at the ignition status/set attenuation checkpoint (FIG. 16: 1609), were the Control Unit requests the ignition status from the Condition Unit. The Control Unit will also normalize the transmission and reception antenna system for garage entry.

This checkpoint outcome coupled with the status of two other checkpoints:
1. The Sentry Mode Flag (FIGS. 16: 1632), and
2. The garage Entry/Exit Flag (FIG. 16: 1611).
   Will indicate:
   Whether the vehicle is [parked outside]/[approaching the front] of the garage in zone 1;
   Parked within the garage in zone 2;
   Parked within the garage in zone 2 and in Sentry Mode.

If checkpoint (FIG. 16: 1611), indicates a presence of the vehicle within the garage, indicated by: Yes (ie: Set to a logical high) and the ignition checkpoint indicates the ignition is on (ie: Also Set to logical high), then the vehicle is within the garage, the ignition is on, the portal is authorized to Open and the garage entry/exit flag is reset to Logical low.

If checkpoint (FIG. 16: 1611) is set low, then the vehicle is within zone 1, authorized and approaching the portal. There are two logical options at this point, either the operator desires to enter the garage or, the operator for some reason, desires to park in front of the garage.

### User Configurable Count Down Timer

To deduce which of the above options the operator of the vehicle has chosen, the system requires the operator when setting up the Control Unit (see Control Unit Initialization for details), to enter a preferred delay period ranging from 0 to 60 Seconds, into the operating preferences of the Control Unit Software. The operator may choose the zero second option and have instant response to entering the portal within zone 1, in this case, the operator may always need immediate entry to the garage on arrival into zone 1.

If this is not always the case and the operator requires to sometimes park the vehicle in front of the garage, without opening the portal. The system has been set up, so that, on entering zone 1, the operator will have a preset time to turn off the ignition of the vehicle, park the vehicle and remain in front of the portal without it being opened. On arrival into zone 1, a count down timer will activate (FIGS. 16,1613), and a continuous monitoring cycle of the ignition status will begin (FIG. 16, path: 1614→1609→1611→1613→1614). There are two ways to make an Exit from this cycle:

The first is where the ignition is turned off (FIG. 16, path: 1609→1616), the portal remains closed and the vehicle is parked in zone 1, in front of the portal. In this case the portal will remain closed unless a force open command was received by the Control Unit.

Note: The force open command will require a re-establishment of vehicle authorization.

The second is to wait for the count down timer to expire. When this happens the portal is opened and vehicle is authorized to enter the garage.

### Garage Entry Process

After the garage portal is opened, there is a fixed time delay (FIG. 16: 1627), which allows for the vehicle to be driven into the garage (zone 2). On expiry of the time interval, the close portal process commences. The process cycles through closing the portal for a few seconds, checking for an obstruction, checking if the overall process is taking too long, waiting for a few seconds and checking if the portal is closed (FIG. 16, path: 1629→1630,1631→1628→1632 respectively). If the overall process takes too long, then the system will engage obstruction/tampering alarms, which are resettable from the Control Unit.

### Sentry Mode

After entering the garage, the system will check if sentry mode has been set up as a preference (FIG. 16, checkpoint 1633). If sentry mode has been enabled, then the Control Unit firstly sets a Sentry Flag to a logical high and initiates a encryption key update cycle while the ignition is off (FIG. 16, path: 1636, 1638, 1637). This cycle can be terminated in three ways:
Failure of Sentry flag verification (FIG. 16: 1637), resulting with: System auto reset (FIG. 16, path: 1637→1601);
Failure to update the encryption key, the system will engage the alarm (FIG. 16, path: 1938→1626);
By vehicle ignition turn on, indicates that the operator wishes to move the vehicle out of the garage (FIG. 16, path: 1636→1639).

On exiting the cycle the sentry flags are reset to low. Sentry mode is designed to put an electronic leash between the Control Unit and the Condition Unit, and specifically is an anti theft initiative. If the vehicle is physically moved out of the Sentry Tx and Rx range warning alarms are automatically engaged by the system (FIG. 16: 1626, 1642).

Note: Alarm systems (FIG. 16, 1626) may include other options like vehicle alarm activation, silent alarm, mobile phone text warning or in the extreme case: vehicle immobilization (FIGS. 17, 1711 & 1712).

Vehicle Garaged without Sentry Mode

If sentry mode has not been chosen as a preference, then the system will go to checkpoint: FIG. 16, 1640. This checkpoint briefly switches into sentry mode to establish whether the vehicle is garaged and sets the garage entry/flags high indicating to the system when the ignition is turned on that the vehicle is parked in the garage.

### Garage Exit Process

If the Vehicle is parked within the garage, ignition turn on will restart the Control Unit Procedure, regardless if the vehicle was or was not in sentry mode. As the Cluster Unit is within range (see Cluster Unit Details), authorization of the Vehicle, Control Unit type and the various flags (FIG. 16, path: 1606→1607→1609→1611→1612→1610→1608) proceeds quickly and the portal is opened. As the vehicle moves out of zone 1, either the Rf communication drops out or the timer expires (FIG. 16, 1627), the system begins the close portal procedure.

### Control Unit Initialization

After installation and power up of the Control Unit, the operating system will request the setting up of preferences by the user. The table below summarizes the preference type, setting and setting method.

| Preference | Setting | Method |
|---|---|---|
| Auto Range Distance | . . . | Set by User vehicle |
| | | placement (see |
| | | normalization Procedure) |
| Entry Count down timer | 0-60 Sec | By User Entry |
| Sentry Mode | On/Off | By User Entry |
| Control Unit Count Down | 0-5 Sec | By User Entry |
| timer | | |
| Condition Unit ID | By specific entry | By User Entry |
| Cluster Unit Deployment | Singular Mode/ | By User Entry |
| Setting | Group Mode | |
| Number of Cluster Units & | By specific entry | By User Entry |
| their operator ID's | | |
| Alarm/type(s) activation | On/Off | Reset by: Sequential |
| | | Force Close button |
| | | pushes on Control Unit. |
| Vehicle Immobilization | On/Off | By User Entry |

### Condition Unit Software/Hardware Operation

In the garage entry field of use:

The Condition Unit will be carried in the vehicle (often called the Car Unit). This unit will have at least one variable input line connected to the electrical system of the vehicle, specifically to monitor the state of the ignition, other vehicle system variables can also be implemented and monitored if required.

### Condition Unit Software Operation

### Condition Unit Encryption Key Update Procedure

In the garage entry field of use:

The encryption key update procedure is specific to each set of paired units and therefore each pair of units has its own unique key.

For the Control and Condition Unit pair communication, the Control Unit (as the principal unit) generates the 192 bit encryption key, updates and verifies the key and sends the key to the Condition Unit (FIG. 22).

For the Condition and Cluster Unit pair communication, the Condition Unit (as the principal unit) generates the 192 bit encryption key, updates and verifies the key and sends the key to the Cluster Unit (FIG. 22). The main reason for this protocol is to conserve the battery life of the Cluster Unit as both the Condition Unit and the Control Unit are connected to sizable power sources.

The Condition Unit will listen for a query from the Control Unit. Once handshaking with the Control Unit has been established and the ID verified through encrypted communication between the two units, the Condition Unit checks if there is a command from the Control Unit to discontinue the polling of the Cluster Unit (FIG. 17, checkpoint: 1703).

Cluster Unit Polling from the Condition Unit

If there is no command to stop the polling, the system initiates a count down timer (FIG. 17, 1705), to place an initial time limit on a repeating cycle of sending a query and listening for a response from the Cluster Unit (FIG. 17, path: 1707→1705). If the cycle goes to time out then the system restarts (FIG. 17, 1701), if there is a response and the Condition Unit establishes a valid authentication from the Cluster Unit, the count down timer is reset to maximum and the system moves onto checkpoint FIG. 17, 1709.

If there is a command to stop the polling then the system stops the countdown process (as it is not needed any more) and moves to checkpoint FIG. 17, 1709.

### No Paired Cluster Unit

Checkpoint FIGS. 17, 1709 and 1710 (enclosed in dashed box 2), is available only on systems without a Cluster Unit and complement the Condition Unit with force open and force close buttons.

### Multiple Paired Cluster Units

For Multiple paired Cluster Units, the checkpoints FIGS. 17, 1704, 1705, 1706,1707 and 1708 (enclosed in dashed box 1), are replicated for each paired Cluster Unit.

### Mimicking Antenna Attenuation

The Condition Unit at this checkpoint (FIG. 17, 1708), will reset (mimic) its antenna status to the status of the Control Unit.

### Immobilization Command

Checkpoint FIG. 17: 1711, determines whether there has been a immobilization command form the Control Unit and FIG. 17, 1712,

### Condition Unit Checkpoints/Data Digital Status Monitoring

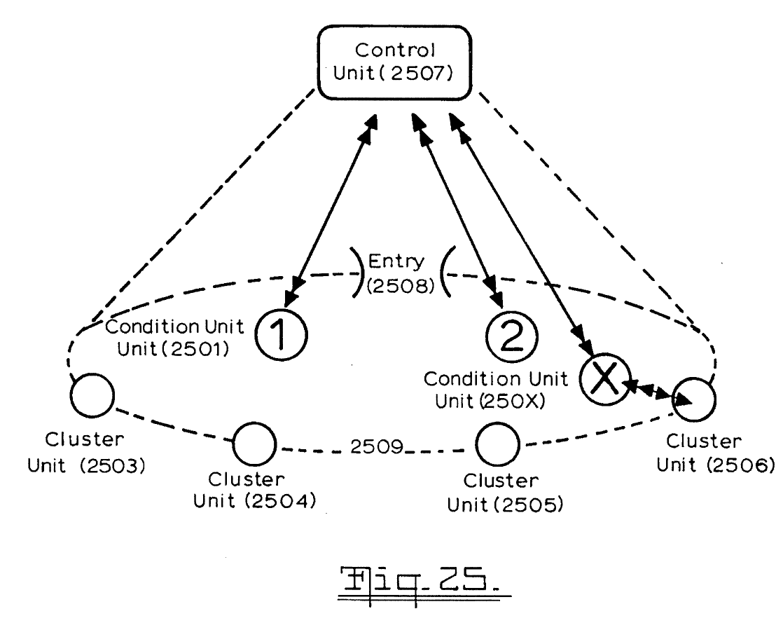

Checkpoints FIG. 17, 1713→1716 are the backbone of the Condition Unit as they feedback to the system (including the Control Unit) information relating to the electrical status (for the vehicle field of use) of the carrier. Examples of possible variables are: Ignition Status, Vehicle ID, Tire Pressure Status, Temperature, etc. Note that: Checkpoint FIGS. 17, 1715 & 1716, is an symbolic checkpoint which is able to expand to accommodate ‘n’ variables (ie: incorporate ‘n’ extra checkpoints), so that any number of ‘n’ possible variables can be monitored.

### Boom System Check

Checkpoint FIGS. 17, 1717 & 1718, Determines if the Control Unit is being used in a boom gate system and if so will reset the Condition Unit system for boom gate operation.

### Sentry Mode Check

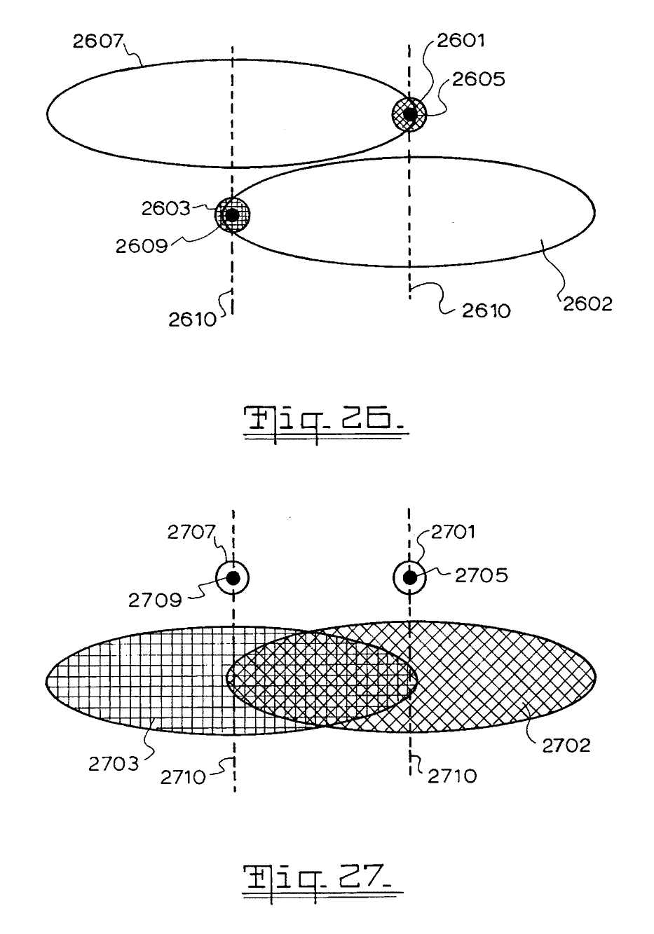

Checkpoints FIGS. 17, 1719 & 1720 & 1721, determine if the Control Unit is in sentry mode and if so sets up the Condition Unit system for sentry mode.

### Cluster Unit Software/Hardware Operation

In the garage entry field of use:

The Cluster Unit will be attached to the vehicle key fob (often called the Key Fob Unit). This unit will have the capability to force close or open the garage portal, by sending encrypted command(s) to the Control Unit.

The Cluster Unit is the only unit that requests a secure encryption key update to be sent to it from the paired Control Unit.

In the mass transit field of use:

Since there is a plurality of Condition Units, the Cluster Unit requests the encryption key of the paired Condition Unit and returns the new key and its physical and electronic ID to the Condition Unit encrypted with its old key. The Condition Unit re-transmits this communication to the Control Unit.

### Cluster Unit Software Operation Singular Mode

The Cluster Unit has a very simple operating procedure, either it is executing a force command to the Control Unit (FIG. 18, 1801) or it is responding with a proximity request with the paired Condition Unit.

To conserve the battery life of the unit all possible intensive calculations have been delegated to the other units.

In the case of a force command issued to the Control Unit, The Cluster Unit will establish handshaking with the Control Unit. The Control Unit via the physical ID of the said Cluster Unit will identify its type and proceed to send a new key update (FIG. 18, 1803), if the key update is successful then the Control Unit will decrypt the force command and execute the request (FIG. 18, 1804).

All force commands have priority over all other processes and must be executed immediately when authorized.

In the case no force command, the Cluster Unit waits for a key update request from the Condition Unit. A successful update (FIG. 18, 1805) procedure indicates that the Cluster Unit is within range and enables the Condition Unit to proceed with Communications with the Control Unit.

### Cluster Unit Software Operation Group Mode

The Group Mode deployment of the Cluster Unit is mainly directed to the secure access control of mass transit of people for example: Ticketing, Border Crossing international Airport traffic.

Group Mode entails a secure multi tasking program kernel that runs the Control Unit, Condition Unit and Cluster Unit software with a plurality of Condition Units and a fixed number of Cluster Units embedded into turnstiles (FIG. 24). Every Condition Unit will initiate a separate procedure with the same Control Unit and all embedded turnstile Cluster Units. Each of these said procedures are redundant and therefore software crashes in any one (or a number) of procedures running simultaneously will be localized to the said procedures only and will not crash the larger system.

The difference between the singular procedure and the group procedure is in the encryption key update transfer to the Cluster Units.

The multi tasking program kernel will have access to secure online databases of the carriers of the Condition Units, for ID authentication and verification. The said program kernel will also have access to a database of all of the embedded Cluster Unit ID and currently assigned TDES and Global TDES encryption keys.

### Expanded Field of Use Applications and Attributes of the Three Units

The Control Unit as a base station transceiver with its mains power connection and the capability of linking to other Control Units has the capacity to define secure areas and their perimeters. This is achieved by the physical positioning of single Control Units for small areas or many Control Units for large areas and the union of their collective antenna directivities.

The Control Unit has its own memory, it can pair to other Control Units, it has access to external databases and is able to securely communicate with the Condition Unit.

The Condition Unit is a transceiver powered from the carrier and/or on board power supply, it can pair to other Control Units, it also has its own memory and has the capacity of electronic interactivity with the carrier. This allows the monitoring and control of specific carrier systems. With a biological/biometric/electrical interface the monitoring could apply to all bio-species as well as any electronic/robotic device.

The Cluster Unit has an onboard rechargeable battery system and/or mains power. It has limited memory reserved for its: ID Code, Carrier ID, Paired ID etc., as well as a secure proximity capability with the Condition Unit.

The Cluster Unit can pair to the Control Unit as well as the Condition Unit, which when in proximity, enables secure communication between the Control and the Condition Unit. The Cluster Unit also has the capability to force command the Control Unit.

FIG. 23 illustrates the versatility of this unit.

Academically the Cluster Unit is considered to not be needed in single portal (blind) corridors (eg: FIG. 23, 2312, 2315), as the Condition Unit entering the portal area should be enough to securely access a portal. However with the cluster area of the Cluster Unit and the possible interior reflections of the Control Unit's Rf field in some installations (ie: underground), creating null zones, the Cluster Unit offers a more accurate and practical detection area for secure portal access. FIGS. 23: 2307, 2311, 2313 and 2314 are all Control Units in a winding corridor. The fields: 2308, 2310, 2312, 2315 respectively are the fields associated with the Control Units. In practice the fields of Control Units 2313 and 2315, will not be as defined as illustrated, for example field 2315 may encroach severely into field 2312. If there was another portal on the opposite side of 2314 then given that this portal suffers from the same field dispersion problem as 2314, the Condition Unit would have difficulty clearly delineating entry into the intended portal. Cluster Units are needed in these situations.

The area controlled by Control Unit 2307, has four exits of which two are specified (FIG. 23: 2309 and one of 2306), all of the Cluster Units are placed on the perimeter of the Rf field of Control Unit 2307. The operation of the Cluster Unit is as described above:

When the Control Unit is within proximity of the specifically paired Cluster Unit, the process of authentication and identification identifies the portal and the entry process is initiated.

Another aspect of multiple portal control is illustrated by FIG. 23: If we consider the Control Unit 2301, it has two defined areas of control area 2302 (shaded area) and 2303 (white area inclusive of 2302), access to the areas is controlled through several portals 2305 (in to the larger area) and 2302 (into the smaller area). The two areas 2302 and 2303 have different security clearances. The Control Unit 2301 controls access to both of these areas by the appropriate attenuation of its antenna radiation pattern. Each Cluster Unit on the perimeter of each area offers specific small field electronic access control of each portal.

### Mass Transit Field of Use

In this field of use we have the Cluster Units embedded in the turnstiles and in communication with the Control unit on a controlled attenuation basis, where the turnstiles are situated near the perimeter of the portal area of the Control Unit. The main function of the embedded Cluster Unit, is to securely detect and inform the Control Unit of the presence of the Condition Unit(s) in proximity of the Cluster Area.

The TDES Key updates of the turnstiles (embedded Cluster Units) are transit event based and occur during the ID and fiscal verification of the Condition Unit (note: The global updates occur separately).

The Condition Unit is embedded within a form factor similar to the commonly used (swipe) entry card that is in general use at present (but a little thicker) and carried by the carrier, in this case a person.

On immediate entry of the Condition Unit to the portal area (FIG. 25: 2508), Rf communication between the two units is initiated and the authentication process commences (FIG. 25 double arrow heads).

More Specifically the Control Unit:
Validates the Condition Unit TDES Key (Activation ID) and
Updates the Condition Unit with the latest Global TDES key and
Validates the electronic ID and Physical ID;
Validates the financial requirements and
Sets a synchronized fixed ticketing time limit for both units via an on board timer which on expiry will reset the access privileges set by the said Control Unit;
Places all information relating to the Condition Unit into a present table that is held until the ticketing time expires. The information is placed in this present table to enable a quick fee deduction and consequent verified access to the transit system through the chosen Cluster Unit;
Commands the Condition Unit to disproportionally attenuate its Tx and Rx Fields (FIGS. 27: 2701 and 2702, Note that: The Tx & Rx fields have been vertically separated [FIG. 27: 2710] for illustration purposes only).

Note also: This process will need access to a specifically designed transit database and depending on the size and speed of the system, access times may take a few seconds.

The purpose of the disproportionate fields is:
Disable further communication with the Control Unit to save battery life of the Condition Unit and
Disable inter Condition Unit handshaking also to save battery life.

The Control Unit will:
Asynchronously trigger a Global Key update based on a set period and an communication event after, but near the expiry of the said period,
Transmit the update to the Cluster Units and
Transmit a periodic communication query to initiate new Condition Unit communication.

All Cluster Units will have disproportionally attenuated Tx and Rx fields in normal communication with the Condition Units.

This is illustrated in FIG. 26, where 2601 and 2602 are the Tx and Rx fields of the Condition Unit with 2605 as the antenna of the said Condition Unit and 2607 and 2603 are the Tx and Rx fields of the Cluster Unit with 2609 as the antenna of the said Cluster Unit (Note that: The Tx & Rx fields have been vertically separated [FIG. 26: 2610] for illustration purposes only).

Unattenuated communication with the Control Unit will only be used during:
Global Cluster Unit TDES Key Updates (triggered by the Control Unit)
Condition Unit ID and fiscal verification/processing and associated Cluster Unit
TDES Key updates and
Exit/Entry authorization

The Condition Unit when in proximity to the Cluster Unit will communicate with the said Cluster Unit via the disproportionate fields and after ID validation and fiscal verification with the Control Unit via the Cluster Unit, the carrier will be allowed passage through the portal.

More Specifically the Cluster Unit will:
Receive Condition Details via the Global TDES Key
Decrypt the said details and re-encrypt them in its own TDES Key
Validate the said details through a TDES Key update with the Control Unit.

If the passage to/from the actual transit system requires further portal (Cluster Unit) access/thoroughfare, the disproportionate field mode of the Condition Unit will remain enabled.

The attenuated disproportionate field mode of the Condition Unit will be reset when the carrier passes through the specific transit exit turnstile.

For a larger transit volume through put, the length of the foyer can be constructed such that the walking time across the foyer is longer than the database query/encrypted communication/access time of the system.

An illustration of a foyer (portal area) and turnstile (cluster) area (FIG. 24: 2401), is exemplified in FIG. 24 and also in isometric view in FIG. 25, where FIG. 24: 2402 (FIG. 25: 2509), is the foyer leading into the turnstile area (see Cluster Unit Software Operation Group mode). Note that the portal area is enveloped by the Control Unit field (FIG. 25: 2507).

By the time the carrier has entered the turnstile cluster area through the initial gate (FIGS. 24: 2407 and 2403), the Cluster Unit (FIG. 24: 2401) only needs to validate the ID and fiscally verify and execute the transaction. This is illustrated by the double arrows in FIG. 25: 250X (where X defines one or a plurality of Condition Units) and if authorized, the Cluster Unit will open the portal FIG. 24: 2405 (FIG. 25: 2506) and the carrier (FIG. 25: 250X) may pass through without impediment FIG. 24: 2408, (FIG. 25: 2506). If the carrier is not authorized to enter, the gate will not open (FIG. 24: 2406) and the person will be directed back into the foyer (FIG. 24: 2404) via FIFO queuing pressure.

This system can be generally applied to any application requiring secure access control of a plurality of carriers through a multi gate portal perimeter (FIG. 25: 2509).

### Association of Fields of Use

The Condition Unit in the Mass Transit field of use can also incorporate the on board function of the Cluster Unit in the Car Entry Field of use. Diversifying the versatility, applications and practicality of two systems into a marriage between transit and personal access. Amalgamations with other fields of use are also possible. Commercial Boom/Sliding/Swing Gate Application

### Intuitive Boom Gated Entry/Exit

FIG. 8 illustrates a Condition Unit traveling within a vehicle [or carrier] (0806), on a road (0814) with two boom gates (0815 and 0819) either side of the road (0814) and two Control Units (0820 & 0821) either side of the boom gates.

If we define:
The Tx and Rx of the fields Condition Unit (0809) within the vehicle (0806) are in unattenuated mode and
Both of the Control units (0820 and 0821) have their Tx and Rx in Boom Mode (as per unit set up);

These combined settings are defined as mode 2 settings.

and
The Tx and Rx of the Condition Unit (0809) within the vehicle (0806) are both attenuated and
Both of the control units (0820 and 0821) have their Tx and Rx normalized (as before);

These combined settings are defined as mode 3 settings.

The Control Units (FIGS. 8: 0820 & 0821) are positioned to monitor traffic in both directions on a specific user defined access road (FIG. 8: 0814). The Control Units (FIGS. 8: 0820 & 0821) control the operation of the boom gates (FIGS. 8: 0815 & 0819) respectively.

As a vehicle (FIG. 8: 0806) approaches the boom gate (FIG. 8: 0815) in mode 2, field attenuation (by the Condition Unit mimicking the Control Unit status) occurs and Rf handshaking begins as the Tx (FIG. 8: 0803) and Rx (FIG. 8: 0807) field of the Condition Unit (FIG. 8: 0809) within the vehicle (FIG. 8: 0806) and the Control Unit (FIG. 8: 0820) move into transmission range. On the establishment of a validated ID, through encrypted transmission with the Control Unit (FIG. 8: 0820), authentication and identification of the Control Unit (FIG. 8: 0820) with type; Boom is established.

Note: Boom and garage systems are singular mode systems and do not require the Cluster Unit Operation once secure authentication has been established. The Control Unit issues a discontinue polling command to the Condition Unit (FIG. 16, 1605) and the Control Unit responds (FIG. 17, 1704), by stopping the timer. On establishing the Control Unit type, the unit immediately adopts Boom Mode and sets its Tx and Rx, Rf fields to the appropriate mode 3 attenuation (FIGS. 9, 0907 and 0903). The Condition Unit follows suit (FIG. 17, 1717) and also sets to Boom Mode. Clearly at this point no other carrier but the Condition Unit can communicate with the Control Unit, which, at this point updates the key to positively identify the proximity of the carrier to the Control Unit, before initiating the open boom sequence.

In the case of a carrier approaching a boom gate on both sides of the road traveling in opposing directions as illustrated in FIG. 10. The above process applies similarly to carriers approaching from both sides of the road as illustrated in FIGS. 10 and 11. Note that: The combination of physical separation, placement, secure ID Codes, antenna field directivity and attenuation, eliminate unwanted cross communication between Boom Gates. On recognition of Boom mode both carriers attenuate their Rf fields to mode 3 and are therefore placed in front of the boom by the system. For many carriers in queue the system will identify and grant passage to authorized carriers on a FIFO basis.

### Multiple Single Gate Sequential Entry System

FIG. 12 illustrates a vehicle (1201) containing a Condition unit (1202) at the entry of a four gate sequential entry system with unattenuated Tx (1204) and Rx (1203) Rf fields.

Each of the four gates are physically identical in physical set up, except for the ground loops (1212) in gates 1, 2 and 3, which gate four does not have. The dotted lines between the Control Units indicate other blind gates controlled by Cluster Units.

In the application of a in building car park for example, one Control Unit would be assigned to each floor and the Cluster units would be assigned for secure access control of the assigned individual client parking areas.

Gate 1 (1216) is different from the other gates, in that it is the only gate with the client database access. This includes: The ID of the client, Condition Unit ID, and the specific gate path to the said client's reserved parking area.

Note: All this information is entered into the Control Unit of gate 1, via its keyboard or securely through an external computer.

On set up (and subsequent updates) of the system the Control Unit of Gate 1, will update the databases of the other Control Units in the system together with a systemic (global) encryption key update.

On detection and subsequent authentication/verification of a Condition Unit, the Control Unit of Gate 1, passes on the necessary encrypted ID parameters to the other synchronized units (wired in series), together with the global encryption key update.

Gate 2 (1213) has the typical capabilities and/or components (as all other gates: from FIG. 12) of:
Two Control Units (1206 and 1210) respectively, with normalized and attenuated Tx (1207 and 1209) fields and attenuated Rx (1205 and 1211) fields;
Normalization of the Control Units is set up by the user via Control Unit key pad;
The Rx fields are again offset from the Tx fields for illustration purposes only;
An electrically operated sliding/swing/Boom/or Other type gate (1208);
A ground loop to allow exit for visitors (1212);
All communication between the Control Unit pairs of each of the gates is encrypted.

If all paired Control Units have the ID and access codes of all authorized Condition Units they can act independently without breaching the security.

The operation of the multiple gate system is similar to the mass transit system, except that the implementation is at a much smaller scale.

After authentication and verification of the incoming Condition Unit, the Control Unit will securely (globally) download onto the other inline Control Units and transmit to the said Condition Unit the updated keys and ID of the Control Units and Cluster Units along the path up to and including the final portal (at the designated parking area of the client). As the carrier proceeds to the designated parking area, the Condition Unit carried by the carrier remains in encrypted communication with the closest Control Unit by updating/validating on every communication event, with all of the Cluster Units (when within communication range) located on the designated path through to and including the final Portal. Once entering the gate system, the antenna attenuation is not reset and mode 3 (FIG. 13) is set until key updating ceases when the ignition is turned off. Visitors to the complex are only allowed in after permission is obtained from a tenant (by visual ID) of the complex. The tenant will then subsequently open the gate(s) as requested from the visitor.

Exit from the complex can be either automatic or secure, the gates are opened by ground loop sensors or with by visual ID through the tenants' permission. The available depth of security (ie security level), is be determined by the Complex Management Committee.

Summary of the advantages of this Invention

From the above, those skilled in the art will realize that this invention differs from previous attempts in:
Expanding the concept of a portal to any device that controls movement or physical access, via entry or exit from a specific entrance or the perimeter of a specific area.
Changing the focus of security access from a door to door series/parallel/array system to a perimeter or an area multiple portal approach.
Introducing the concept of using three devices where:
1. The Control Unit acts as the main director of events
2. The Condition Unit acts as a carrier condition indicator, with the ability to:
   a) Firstly: Transmit to the Control Unit relevant biometric, electrical and specific digitized bio-species monitoring data and
   b) Secondly: Implement electrical shutdown of relevant systems if needed.
3. The Cluster Unit acts as a low power small Rf field unit, that can be used in small field applications within buildings and that can also concatenate several associated secure ID's into a single access event.
Introducing the concept (in the vehicle entry field of use), of the Cluster (or Proximity) Unit as a fail safe portal control device.
Combining the appropriate antenna type configuration with:
   1. Switching the antenna power levels;
   2. Low antenna power levels reducing Rf signal reflections, necessary for RFID to operate within buildings;
Using Disproportional transmission and reception fields for communication between specific devices;
Microprocessor controlled disproportional transmission and receptive field attenuation;
The RFID system becomes an active intuitive portal where entry is controlled by the intent of the user;
The system can be overridden (if needed) via push button selection;
The system can be used to control logistic, personnel and vehicle access.

From the above, those skilled in the art will realise that this invention differs from previous attempts in:
Using the appropriate antenna type combination, together with;
Switching the magnitude of antenna broadcast transmission and reception areas;
The smaller broadcast areas (reduce Rf signal reflections), enable the technology to operate within buildings, and coupled with:

The incorporation of the additional outcome(s) of:
Using disproportional broadcast transmission and reception fields for communication between specific devices;
Microprocessor controlled disproportional broadcast transmission and receptive field attenuation;

The invention becomes a practical, active, intuitive, multi-field, secure portal access control system, with a plethora of applications, where entry is controlled by the intent of the user;

The system can be overridden (if needed) via push button selection;

Those skilled in the art will realise that the present invention may be implemented in embodiments other than those described without departing from the core teachings of the invention. The system may be adapted for use in a wide range of applications and can be designed and shaped to fit the requirements of the desired application(s).

1. A method of automatically operating a portal by determining the intention of an approaching or receding carrier by providing a portable communication device for said carrier and a control (base) unit associated with the control system for said portal in which the antenna transmission and reception areas between specific events are varied either synchronously or independently to determine change in proximity between the control unit and the carrier as an indication of intent to open or close the portal.

2. A method as claimed in claim 1 in which the control unit actuates a door or gate for a vehicle and the portable device identifies the vehicle and or its driver and passengers.

3. A method as claimed in claim 1 in which disproportional attenuation of the transmission and reception field areas of the antenna is provided.

4. A method as claimed in claim 2 in which communication between the base unit and the portable unit is encrypted.

5. An automatic actuation system which includes at least one base unit with the ability to be wirelessly paired with a plurality of remote movable units, each unit including
a) an antenna;
b) an antenna driver to power the antennas;
c) an antenna attenuator to control the attenuation and field strength of the antenna;
d) a paired device encrypted communication and transmission system;
e) a micro-controller to control the operation of the unit.

6. An automatic actuation system as claimed in claim 5 in which the base unit controls the opening and closing of a door or gate for pedestrians and or vehicles.

7. An automatic actuation system as claimed in claim 5 in which the antenna is attenuated by a digital switch.

8. An automatic actuation system which includes at least one base unit with the ability to be wirelessly paired with a plurality of remote movable units, in which the base unit incorporates a keypad and display screen for data input and device set up and also includes
a) an onboard directional antenna that can be attenuated via a digital switch
b) an antenna driver controlled by specific instructions from the micro-controller
c) a communication device for the pairing and synchronization of remote units
d) access to onboard memory
e) a communication link to an actuation means
f) a data line output for connection to external secure monitoring systems.

9. An automatic actuation system as claimed in claim 8 in which the base unit operates a door or barrier opening and/or closing mechanism.

10. An automatic actuation system as claimed in claim 8 in which the remote unit has
a) a separate uni-directional or omni-directional antenna that can be attenuated via a digital switch
b) an antenna driver controlled by specific instructions from the microcontroller;
c) access to an onboard memory.

11. An automatic actuation system as claimed in claim 8 in which the microprocessor controls the digital antenna attenuator to provide disproportional attenuation (either synchronously or independently) of the transmission and reception field areas of the antenna.

12. An automatic actuation system as claimed in claim 10 in which the remote unit has
a) LED Condition indicators visually illustrating the operation of the unit;
b) LED transmission power bar illustrating signal transmission strength;
c) over-ride buttons for manual operation.

13. An automatic actuation system as claimed in claim 8 in which the remote unit is used to identify a vehicle and is paired with a second remote unity fused to identify the operator and or passengers.
